(19) United States
(12) Patent Application Publication
(10) Pub. No.: US 2025/0317808 A1
(43) Pub. Date: Oct. 9, 2025

(54) ANCHORED INTER-NETWORK ENTITY MOBILITY

(71) Applicant: QUALCOMM Incorporated, San Diego, CA (US)

(72) Inventors: Naeem AKL, San Jose, CA (US); Karl Georg HAMPEL, Jersey City, NJ (US); Jelena DAMNJANOVIC, Del Mar, CA (US); Prasada Veera Reddy KADIRI, San Diego, CA (US)

(21) Appl. No.: 19/092,024

(22) Filed: Mar. 27, 2025

Related U.S. Application Data
(60) Provisional application No. 63/574,577, filed on Apr. 4, 2024.

(51) Int. Cl. H04W 36/00; H04W 76/27

(52) U.S. Cl. CPC H04W 36/0055; H04W 76/27

(57) ABSTRACT

Certain aspects of the present disclosure provide techniques for anchored inter-network entity mobility. An example method for wireless communications by a first network entity includes establishing radio resource control (RRC) connection for communications between a user equipment (UE) and the first network entity; sending, to the UE via a first cell, a first configuration for a first mobility operation for a cell switch to a second cell served by a second network entity, wherein the first configuration indicates to use the RRC connection for communications between the UE and the second network entity via the second cell; obtaining, from the second network entity, a second indication of completion of the first mobility operation, where the UE is in communication with the second network entity via the second cell based on the first configuration; and communicating with the UE via the second network entity based on the RRC connection.

### CROSS-REFERENCE TO RELATED APPLICATION(S)

The present Application for Patent claims benefit of and priority to U.S. Provisional Application No. 63/574,577, filed Apr. 4, 2024, which is hereby expressly incorporated by reference herein in its entirety.

### INTRODUCTION

### Field of the Disclosure

Aspects of the present disclosure relate to wireless communications, and more particularly, to techniques for mobility management.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a first network entity. The method includes sending, to a user equipment (UE), a first indication of a radio resource control (RRC) connection for communications between the UE and the first network entity; sending, to the UE via a first cell, a first configuration for a first mobility operation for a cell switch from one or more cells, including the first cell, served by the first network entity to a second cell served by a second network entity, wherein the first configuration indicates to use the RRC connection for communications between the UE and the second network entity via the second cell; obtaining, from the second network entity, a second indication of completion of the first mobility operation, wherein the second indication indicates that the UE is in communication with the second network entity via the second cell based on the first configuration; and communicating with the UE via the second network entity based on the RRC connection.

Another aspect provides a method for wireless communications by a first network entity. The method includes obtaining, from a second network entity, a request for a first configuration for a first mobility operation for a cell switch for a UE from a first cell served by the second network entity to a second cell served by the first network entity while using a RRC connection between the UE and the second network entity for communications between the UE and the first network entity via the second cell, the RRC connection being based on the first configuration; sending, to the second network entity, the first configuration for communications between the UE and the first network entity via the second cell; communicating with the UE via the second cell based on the first configuration; and relaying traffic between the UE and the second network entity based on the RRC connection.

Another aspect provides a method for wireless communications by an apparatus. The method includes obtaining, from a first network entity, a first indication of a RRC connection for communications between the apparatus and the first network entity; obtaining, from the first network entity via a first cell, a first configuration for a first mobility operation for a cell switch from one or more cells, including the first cell, served by the first network entity to a second cell served by a second network entity, wherein the first configuration indicates to use the RRC connection for communications between the apparatus and the second network entity via the second cell; sending, to a second network entity via the second cell, a second indication of completion of the first mobility operation; and communicating with the first network entity via the second cell based on the RRC connection.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIGS. 5A and 5B depict example protocol stacks for exchanging information between a UE and a network entity.

FIG. 6 depicts an example of UE mobility in a wireless communications network.

FIG. 7 depicts an example scheme for anchored inter-network entity mobility.

FIGS. 8A and 8B depict example protocol stacks for anchored inter-network entity mobility.

FIG. 9 depicts a process flow for anchored inter-network entity mobility preparation.

FIG. 10 depicts a process flow for a cell switch for anchored inter-network entity mobility.

FIG. 11 depicts a process flow for traffic forwarding for anchored inter-network entity mobility.

FIG. 12 depicts a process flow for modification of a UE configuration for anchored inter-network entity mobility.

FIG. 13 depicts a method for wireless communications.

FIG. 14 depicts another method for wireless communications.

FIG. 15 depicts another method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for anchored inter-network entity mobility.

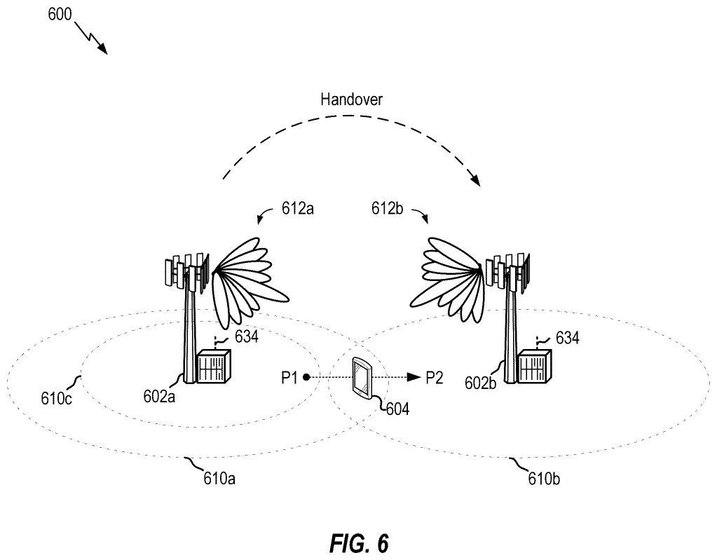

Mobility management is a scheme employed to ensure service-continuity of a user equipment (UE) through handovers and/or beam switching during UE mobility, for example, as the UE moves across different coverage areas of a radio access network (RAN). During a handover, a source network entity (e.g., a base station) transfers a connection with a UE to a target network entity, which may be or include a neighboring network entity (or a neighbor network entity), for example, as further described herein with respect to FIG. 6. A neighboring network entity may communicate via candidate cell(s) and/or beam(s) having a coverage area adjacent to or overlapping with the coverage area of the source network entity. As the coverage area of a single network entity decreases, such as for high-frequency communications (e.g., millimeter-wave (mmWave) communications), the frequency for a UE to handover between network entities becomes high, especially for a high-mobility UE (e.g., a UE traveling in a vehicle). In addition, for applications (e.g., extended reality and/or cloud gaming) characterized with stringent performance specifications (e.g., quality of service (QOS) parameters such as reliability, latency, etc.), the quality of experience may be sensitive to the handover performance, such as unsuccessful handovers. An unsuccessful handover can cause packet losses and/or extra delay during the mobility period, which can cause QoS specifications to not be met for packet-drop-intolerant and low-latency applications.

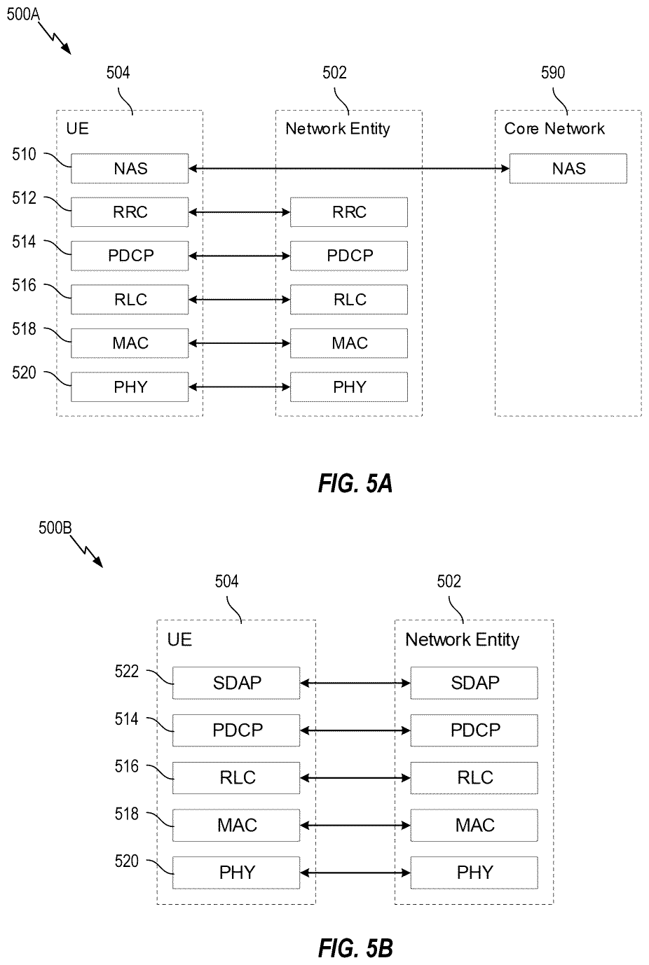

Lower-layer triggered mobility (LTM) may refer to a specific type of handover procedure where a UE is configured, such as via Layer-3 signaling, with multiple candidate configurations for communications via candidate cells, and a network entity changes a serving cell of a UE by a cell switch command, such as signaled via Layer-1 signaling and/or Layer-2 signaling. The cell switch command indicates a candidate configuration for communications via a candidate cell. Then, the UE switches to the candidate configuration for communications via the candidate cell according to the cell switch command. Layer-1, Layer-2, and Layer-3 may refer to certain layers in a control plane protocol stack, for example, as further described herein with respect to FIGS. 5A and 5B. The LTM procedure can be used to reduce the mobility latency, channel usage, and interruption time during a handover, for example, due to the UE being configured with multiple configurations for candidate cells.

Technical problems for mobility management may include, for example, providing effective procedures for inter-network entity mobility, such as inter-network entity LTM. Certain wireless communications systems (e.g., 5G New Radio (NR) systems) may only support LTM for cell changes among candidate cells served at or by the same network entity (e.g., intra-distributed unit (DU) and/or intra-centralized unit (CU) cell switch). For example, the UE may be configured with LTM configurations for candidate cells served by the same CU and/or DU, and the LTM cell switch command may indicate a serving cell change among the candidates served by the same DU and/or CU. However, certain wireless communications systems (e.g., 5G NR systems) may not have established procedures for inter-network entity LTM (e.g., inter-CU and/or inter-base station). More specifically, certain wireless communications systems may have not established the radio resource control (RRC) anchor point for inter-network entity LTM. The RRC anchor point may refer to a network entity (e.g., a CU) that controls a user plane traffic session and/or a control plane traffic session associated with a UE.

Assuming the RRC anchor point is relocated from a source network entity to a target network entity for an LTM cell switch, the RRC anchor point relocation may trigger certain configurations to be updated at the UE and/or signaling exchanges between the UE and the target network entity. For example, to relocate the RRC anchor point from a source network entity to a target network entity during an LTM switch, the RRC connection and/or data traffic session for the UE may be reset to facilitate communications between the UE and the target network entity. Resetting the RRC connection and/or data traffic session may involve, for example, a security key and/or security algorithm change for the RRC connection, a Layer-2 reset (e.g., resetting data buffers for hybrid automatic repeat request (HARQ)), and/or changing the source and/or destination for user plane traffic to the target network entity (e.g., a CU user plane (CU-UP) entity). Accordingly, the RRC anchor point relocation may cause non-trivial latencies and/or interruption times to complete the LTM cell switch for inter-network entity mobility. Note that LTM is an example mobility operation that may encounter an RRC anchor point relocation, and other mobility operations may encounter an RRC point relocation for inter-network entity mobility.

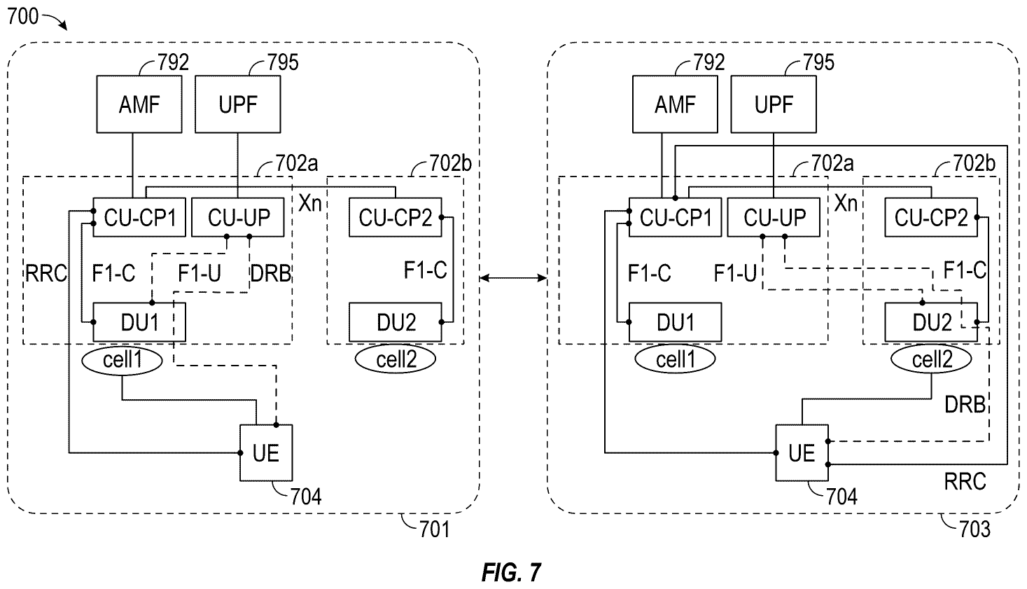

Aspects described herein may overcome the aforementioned technical problem(s), for example, by providing certain techniques for anchored inter-network entity mobility. In certain aspects, a source network entity (e.g., source CU) may remain the RRC anchor point for an inter-network entity mobility operation, such as inter-network entity LTM or the like. As an example, when the UE performs a cell switch (e.g., an inter-CU LTM cell switch) from a first cell served by a source network entity (e.g., a first CU) to a second cell served by a target network entity (e.g., a second CU), the UE may communicate with the target network entity via an RRC connection and/or a protocol data unit (PDU) session established with the source network entity. Thus, the UE retains (or maintains or continues to use) the RRC connection and/or PDU session (e.g., data radio bearer endpoints) established with the source network entity to communicate with the target network entity. The target network entity may serve as a relay (or forwarding) node for communications between the UE and the source network entity. For example, a cross-network entity tunnel may be established between the source network entity and the target network entity as further described herein with respect to FIG. 7. The cross-network entity tunnel may enable data traffic (e.g., user plane traffic) communicated between the UE and the source network entity to flow between the source network entity and the target network entity.

Certain techniques for anchored inter-network entity mobility described herein may provide various beneficial technical effects and/or advantages. The techniques for anchored inter-network entity mobility may enable improved mobility operations, such as reduced latencies, interruption times, packet losses, handover failures, and/or ping-ponging between network entities. For example, the techniques for anchored inter-network entity mobility may enable a UE to use the data traffic session (e.g., a PDU session) and RRC connection established with the source network entity to communicate with the target network entity. Thus, the UE may continue to use the same security key and/or security algorithm for RRC signaling and the same user plane traffic configuration for communications with the target network entity. The techniques for anchored inter-network entity mobility may ensure service continuity for traffic communicated via cells served across a plurality of network entities with reduced latencies and/or interruption times.

The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

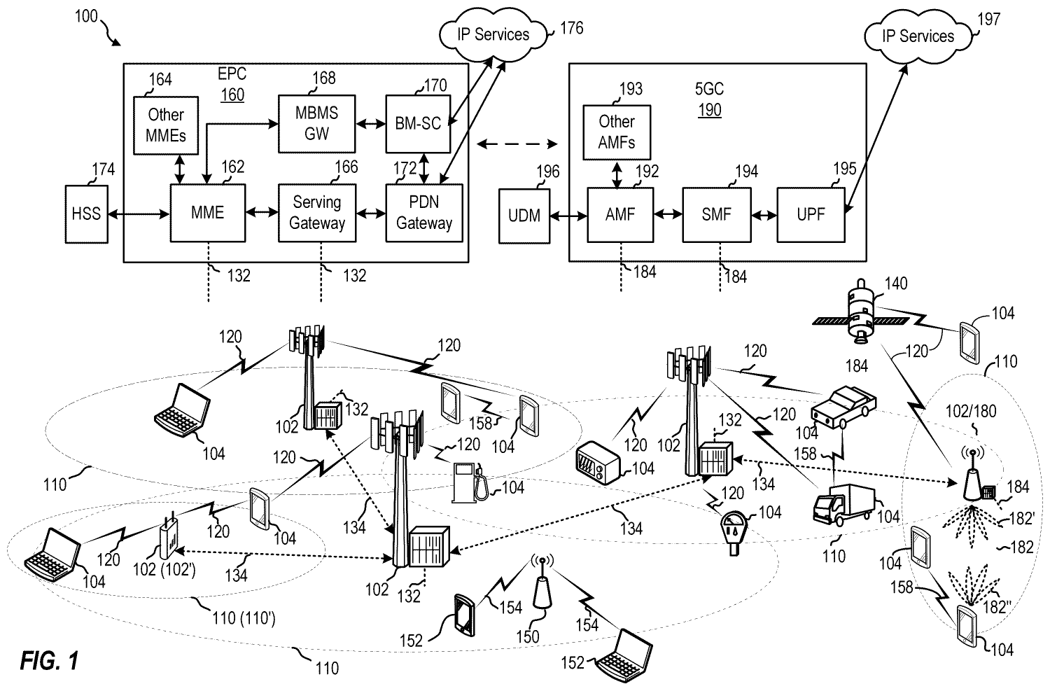

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

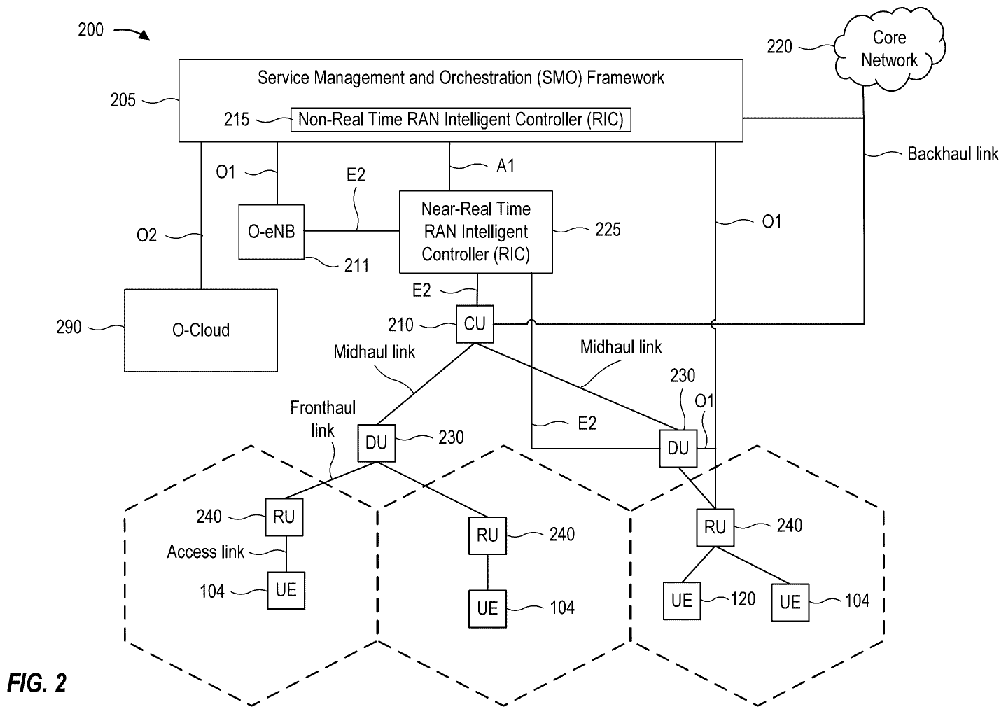

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHz, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mm Wave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an 01 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as AI policies).

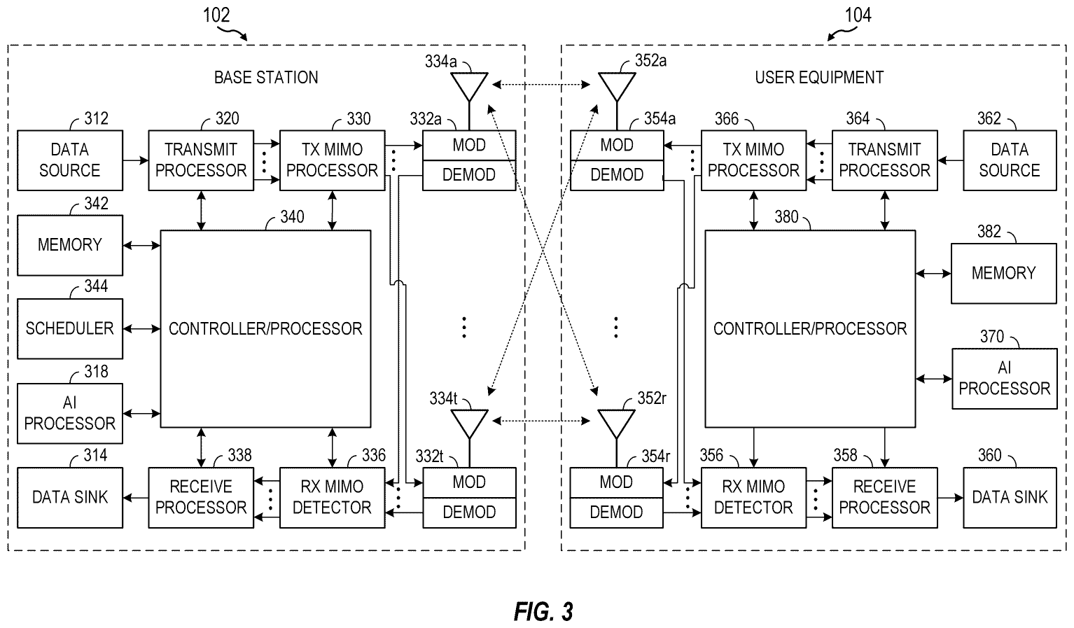

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

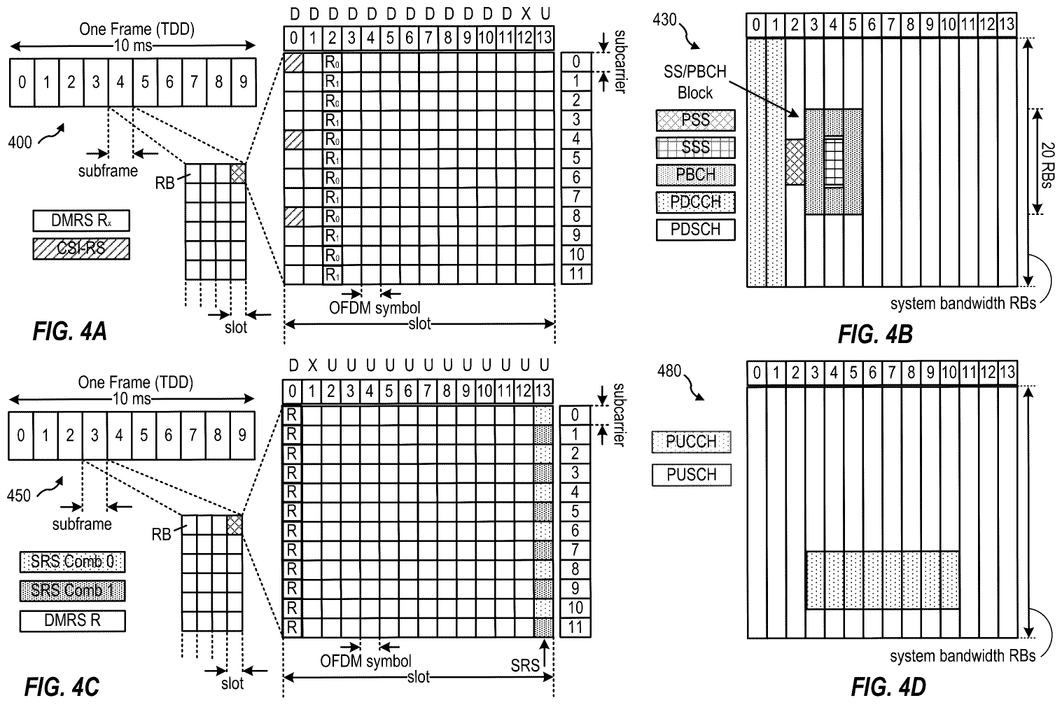

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 24×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Example Protocol Stacks

Certain wireless communications systems (e.g., 5G NR systems or any future wireless communications system) may employ protocol stack(s) to transfer information between a UE and a network entity, such as a base station and/or core network. As an example, 5G NR systems may use a user plane protocol stack and a control plane protocol stack to exchange application data and signaling messages. A user plane protocol stack may be responsible for transferring application data between the UE and an application server and/or data network, and a control plane protocol stack may be responsible for transferring control signaling messages between the UE and a network entity.

FIG. 5A depicts an example control plane protocol stack 500A for exchanging control plane traffic (e.g., control signaling) between a user equipment (UE) 504 and a network entity 502, and between the UE 504 and a core network 590. In some aspects, the network entity 502 may be an example of the BS 102 depicted and described with respect to FIGS. 1 and 3 or a disaggregated base station depicted and described with respect to FIG. 2. Similarly, the UE 504 may be an example of UE 104 depicted and described with respect to FIGS. 1 and 3. The core network 590 may be an example of the 5GC network 190 and/or the core network 220 depicted and described with respect to FIGS. 1 and 2, respectively.

The control plane protocol stack 500A includes a non-access stratum (NAS) layer 510, a radio resource control (RRC) layer 512, a packet data convergence protocol (PDCP) layer 514, a radio link control (RLC) layer 516, a medium access control (MAC) layer 518, and a physical (PHY) layer 520. The NAS layer 510 carries mobility management and session management signaling between the UE 504 and the core network 590 (e.g., the AMF 192 and/or the SMF 194 of FIG. 1). The RRC layer 512 carries RRC signaling, for example, for paging, RRC connection establishment, RRC connection reconfiguration, and RRC connection release. The PDCP layer 514 provides ciphering and integrity protection for control plane signaling. The RLC layer 516 may segment a large packet into smaller packets and handles re-transmissions of RLC packets. The MAC layer 518 schedules transmissions between the UE 504 and the network entity 502 and controls the PHY layer. In the MAC layer 518, the UE 504 and the network entity 502 may communicate with each other by exchanging a MAC control element (MAC-CE). The PHY layer 520 handles transmission and reception across the air-interface between the UE 504 and the network entity 502. The PHY layer 520 provides certain error management tasks (e.g., cyclic redundancy check), certain digital signaling processing tasks (e.g., modulation and demodulation), and handles certain procedures for measurement and control (e.g., beam failure detection and/or radio link monitoring). The network entity 502 may send, to the UE 504, PHY layer signaling via downlink control information (DCI).

FIG. 5B depicts an example user plane protocol stack 500B for exchanging user plane traffic (e.g., application data) between the UE 504 and the network entity 502. The user plane protocol stack 500B includes a service data adaptation protocol (SDAP) layer 522, the PDCP layer 514, the RLC layer 516, the MAC layer 518, and the PHY layer 520. The SDAP layer 522 maps the quality of service (QOS) flow(s) used at the core network 590 (e.g., for a protocol data unit (PDU) session) to data radio bearer(s) used at the network entity 502 to communicate via an air-interface between the UE 504 and the network entity 502. In the user plane, the PDCP layer 514 provides packet header compression (e.g, transmission control protocol (TCP), user datagram protocol (UDP), and/or internet protocol (IP) header compression), ciphering, and integrity protection for user plane traffic.

The RRC layer 512 may form Layer-3 (L3) of the control plane protocol stack 500A. In the user plane, the SDAP layer 522, the PDCP layer 514, the RLC layer 516, and/or the MAC layer 518 may form Layer-2 (L2) of the user plane protocol stack 500B. In the control plane, the PDCP layer 514, the RLC layer 516, and/or the MAC layer 518 may form L2 of the control plane protocol stack 500A. The PHY layer 520 may form Layer-1 (L1) of the protocol stacks 500A, 500B. Layer-3 may include the highest or upper layers in the control plane protocol stack 500A; Layer-2 may include the intermediate layers in the control plane protocol stack 500A, where Layer-2 is arranged between Layer-3 and Layer-1; and Layer-1 may include the lowest layer in the control plane protocol stack 500A.

### Example Mobility Management

FIG. 6 depicts an example of UE mobility in a wireless communications network 600. In this example, the wireless communications network 600 may include a first network entity 602a having a first coverage area 610a and a second network entity 602b having a second coverage area 610b, which may overlap with the first coverage area 610a. The first network entity 602a may also have a third coverage area 610c. In certain aspects, the first coverage area 610a may form a first cell, the second coverage area 610b may form a second cell, and the third coverage area 610c may form a third cell. The first cell and third cell may form or be part of a first cell group, and the second cell may form or be part of a second cell group. The first network entity 602a may communicate via a first set of beams 612a, and the second network entity 602b may communicate via a second set of beams 612b.

Due to mobility (e.g., a UE 604 moving from the first coverage area 610a to the second coverage area 610b), the UE 604 may transition from communicating with the first network entity 602a via the first set of beams 612a to communicating with the second network entity 602b via the second set of beams 612b. As an example, the UE 604 may be located at a first position PI in the first coverage area 610a and/or the third coverage area 610c at a first occasion, and then the UE 604 may move to a second position P2 in the second coverage area 610b at a second, later occasion.

In some cases, the UE 604 may send a measurement report to the first network entity 602a. For example, the first network entity 602a may configure the UE 604 to measure a set of neighboring cell(s) and/or beam(s) of one or more neighboring network entities (e.g., the second network entity 602b). In some cases, the UE 604 may identify neighboring cell(s) and/or beam(s) of a neighboring network entity, for example, via signaling transmitted by the neighboring network entity. The neighboring cell(s) and/or beam(s) may be or include candidate communication link(s) that the UE can handover or switch to from the cell(s) and/or beam(s) of the first network entity 602a. As an example, the neighboring cell(s) and/or beam(s) may include the second cell of the second coverage arca 610b and/or the second set of beams 612b. The measurement report may indicate radio measurements (e.g., signal strengths) associated with the serving cell of the first network entity 602a and/or neighboring cell(s), such as the cell(s) of the second network entity 602b. In certain cases, the measurement report may indicate the signal strengths associated with certain beam(s) of the serving cell and the neighboring cell(s), such as the first set of beams 612a and/or the second set of beams 612b. Based on the measurement report (e.g., indicating a stronger signal strength associated with radio measurements for the second network entity 602b relative to the first network entity 602a), the first network entity 602a may determine to handover (HO) communications with the UE 604 to the second network entity 602b. The first network entity 602a may be in communication with the second network entity 602b via a backhaul link 634 (e.g., an F1, Xn, and/or NG interface) in order to exchange information for the handover.

In the context of a handover or mobility operation, the first network entity 602a may be referred to as a source network entity; and the second network entity 602b may be referred to as a target, candidate, neighbor, or neighboring network entity. During a handover, the source network entity transfers a connection with a UE to a target network entity. A candidate or neighboring network entity may be a possible target for a handover, and the candidate or neighboring network entity may communicate via candidate cell(s) and/or beam(s) having a coverage area adjacent to or overlapping with the coverage area of the source network entity.

In some cases, the handover may involve a CU/DU handover, such as inter-DU-intra-CU handover and/or inter-CU handover. For example, the handover may involve a handover from a source DU to a target or candidate DU in communication with a common CU (e.g., inter-DU-intra-CU handover). In some cases, the handover may involve a handover from a source CU to a target or candidate CU (e.g., inter-CU handover). Accordingly, the first network entity 602a and/or the second network entity 602b may be an example of an RU, DU, and/or CU.

Note that the handover illustrated in FIG. 6 is an example of a mobility operation, such as inter-network entity LTM. Aspects of the present disclosure described herein may be applied to various types of UE mobility operations including, for example, (conditional) LTM, L3 mobility, an Xn based handover, an N2 based handover, conditional handover, beam selection, beam switch, (conditional) serving cell modification or change, (conditional) serving cell addition, (conditional) serving cell release, cell group modification, cell group addition, cell group release, dual active protocol stack (DAPS) handover, dual connectivity, or the like. A mobility operation or handover may be triggered, for example, due to radio conditions (e.g., in response to a measurement report), load balancing at a network entity, and/or a specific service (e.g., to ensure wireless communications performance satisfies certain QoS specification(s)).

### Aspects Related to Anchored Inter-Network Entity Mobility

Aspects of the present disclosure provide certain techniques for anchored inter-network entity mobility, which may enable reduced latencies and/or interruption times for certain mobility operation(s).

FIG. 7 depicts an example scheme 700 for anchored inter-network entity mobility. In this example, a UE 704 may be in communication with a source network entity 702a via a first cell (cell1), and a second cell (cell2) served at or by a target network entity 702b may be a possible candidate cell to which the UE can handover for communications. The first cell may be an example of the first cell formed by the first coverage area 610a of FIG. 6, and the second cell may be an example of the second cell formed by the second coverage area 610b of FIG. 6. Any of the source network entity 702a and the target network entity 702b may be or include a disaggregated network entity, for example, as described herein with respect to FIG. 2. As an example, the source network entity 702a may include a source DU (DU1), a source CU control plane entity (CU-CP1), and a source CU user plane entity (CU-UP). The target network entity 702b may include a target DU (DU2) and a target CU CP entity (CU-CP2).

At a first phase 701 (e.g., a mobility preparation phase), a UE 704 may establish a control plane traffic session (e.g., an RRC connection) and/or a user plane traffic session (e.g., a PDU session and/or data radio bearer(s) for the PDU session) with the source network entity 702a. The source network entity 702a may notify the core network (e.g., AMF 792 and/or the UPF 795) of the user plane traffic session and/or the control plane traffic session between the UE 704 and the source network entity 702a. As part of establishing the control plane traffic session and/or the user plane traffic session, the UE 704 may be configured with radio bearer(s) for communications via the first cell. The radio bearer(s) may include, for example, one or more signaling radio bearer(s) (SRB(s)) and/or one or more data radio bearer(s) (DRB(s)). In certain aspects, the UE 704 may communicate with the source network entity 702a based on a security algorithm configuration associated with the control plane traffic session and/or the user plane traffic session. The security algorithm configuration may indicate or include a security key and/or security algorithm (e.g., a ciphering algorithm and/or integrity protection algorithm) to be used for radio bearer(s). In certain aspects, the UE 704 may communicate with the source network entity via a PDCP entity and/or SDAP entity for traffic associated with the control plane traffic session and/or the user plane traffic session, respectively.

In certain aspects, the UE 704 may obtain, from the source network entity 702a, a first configuration for a mobility operation that indicates the UE 704 may retain (e.g., maintain or continue to use) the control plane traffic session and/or the user plane traffic session between the UE 704 and the source network entity 702a for communications with the target network entity 702b via the second cell. The first configuration may indicate to retain, for communications via the second cell, certain parameter(s) established for the control plane traffic session and/or user plane traffic session between the UE and the source network entity. As an example, the first configuration may indicate to retain, for communications via the second cell, the security algorithm configuration established for the control plane traffic session and/or user plane traffic session between the UE 704 and the source network entity 702a. In certain cases, the first configuration may indicate to retain, for communications via the second cell, the PDCP entity and/or SDAP entity (and/or corresponding PDCP layer configuration and/or SDAP layer configuration) established for the control plane traffic session and/or user plane traffic session between the UE 704 and the source network entity 702a. In certain cases, the first configuration may indicate to retain, for communications via the second cell, the radio bearer(s) established for the control plane traffic session and/or user plane traffic session between the UE 704 and the source network entity 702a.

In certain aspects, the UE 704 may obtain, from the source network entity 702a, a second configuration that indicates certain parameter(s) for communications via the second cell. The second configuration may indicate or include certain parameter(s) for a lower layer entity (e.g., RLC entity and/or MAC entity) associated with the control plane traffic session and/or user plane traffic session configured for an upper layer entity (e.g., PDCP entity, SDAP entity, and/or RRC entity). The second configuration may indicate that the upper layer transport configuration established with the source network entity 702a is expected to be used for the lower layer communications via the second cell. The second configuration may indicate or include a cell group configuration that indicates a set of parameters for communications via the second cell, for example, as a part of a cell group. The second configuration may indicate a logical channel for communications via the second cell, such as an RLC bearer configuration associated with the cell group configuration. The logical channel may include a radio bearer identity (e.g., an SRB identity and/or DRB identity) corresponding to a radio bearer that the UE 704 establishes and retains for communications via the second cell upon a cell switch. As an example, the cell group configuration may indicate or include radio bearer(s) for communications via the second cell. The cell group configuration may indicate or include the synchronization signaling configuration associated with the second cell, such as the SSB burst pattern, SSB frequency locations, SSB burst periodicity, etc. The cell group configuration may indicate or include certain parameters for uplink and/or downlink bandwidth part(s) (BWP(s)) associated with the second cell, such as the frequency domain location and bandwidth or size of the respective bandwidth part, the subcarrier spacing, and/or cyclic prefixed used in the respective bandwidth part. The cell group configuration may indicate or include the time-division or frequency-division duplexing mode for the second cell. In certain aspects, the cell group configuration may indication or include the time-division duplexing (TDD) pattern for transmission time intervals (e.g., slots and/or symbols) associated with communications via the second cell.

At a second phase 703 (e.g., a handover or cell switch phase), the UE 704 may perform a mobility operation, such as a cell switch (e.g., an LTM cell switch) to the second cell. The second phase 703 may occur after the first phase 701. Any of the operations described herein with respect to the first phase 701 may occur during the second phase, or vice versa. The UE 704 may switch from communicating via the first cell to communicating via the second cell, for example, in response to (in association with or after receiving) a cell switch command. In some cases, the UE 704 may perform the mobility operation in response to (or based on) certain criteria being satisfied, for example, according to a conditional handover, conditional LTM, conditional serving cell addition, conditional serving cell change, or the like. Based on the first configuration, the UE may communicate via the second cell using the control plane traffic session and/or the user plane traffic session established with the source network entity 702a. The UE may communicate with the target network entity 702b via the second cell based on the RRC connection and/or PDU session established with the source network entity 702a. As an example, the UE may use the security algorithm configuration, the PDCP entity (and/or corresponding PDCP configuration), the SDAP entity (and/or corresponding SDAP configuration), and/or the radio bearer(s) established for the control plane traffic session and/or the user plane traffic session between the UE 704 and the source network entity 702a to communicate with the target network entity 702b. The control plane traffic session and/or the user plane traffic session being anchored at the source network entity 702a may enable reduced latencies and/or interruption times when the UE switches to communicating via the second cell. Accordingly, the first configuration may enable service continuity for traffic communicated via the second cell, which may enable reduced latencies and/or interruption times for wireless communications via the second cell.

The source network entity 702a may notify the core network (e.g., the AMF 792 and/or UPF 795) that the source network entity 702a is a termination or anchor point in the radio access network for the control plane traffic session and/or the user plane traffic session of the UE during the second phase of the mobility operation. The source network entity 702a may notify the core network that the UE is in communication with the source network entity 702a via the second cell of the target network entity 702b. As an example, the source network entity 702a may send, to the core network (e.g., the AMF 792), an indication of user location information associated with the UE. The user location information may include, for example, a cell identity or identifier of the second cell, a tracking area associated with the second cell, an identity or identifier for the target network entity 702b, or the like. In certain aspects, the user location information may include an indication of a mobility operation involving the source network entity 702a and the target network entity 702b. In certain aspects, the user location information may include an indication that the control plane traffic session and/or the user plane traffic session of the UE 704 is associated with the source network entity 702a for the mobility operation. In certain aspects, the user location information may include an indication that the source network entity 702a is a termination or anchor point in the radio access network for the control plane traffic session and/or the user plane traffic session of the UE 704.

The source network entity 702a may remain in communication with the UPF 795 for the user plane traffic session of the UE 704 during the second phase. For example, the source network entity 702a may serve as a termination point for the user plane traffic of the UE 704 in the radio access network, and user plane traffic may be routed through the source network entity 702a while the UE 704 is in communication with the target network entity 702b via the second cell.

The target network entity 702b may serve as a forwarding or relay node for the control plane traffic session and/or the user plane traffic session between the UE 704 and the source network entity 702a while the UE is communicating via the second cell. In certain aspects, a tunnel (e.g., a communication tunnel) may be used between the source network entity 702a and the target network entity 702b for relaying the control plane and/or user plane traffic between the UE 704 and the source network entity 702a. As shown, the DU of the target network entity 702b may route user plane traffic between the UE 704 and the source network entity 702a. For example, the DU of the target network entity 702b may communicate with the CU-UP of the source network entity 702a to relay the user plane traffic via the tunnel. The tunnel may be or include, for example, a F1-U, F1-C, X2-U, Xn-U (which may be between the source CU and target CU), a general packet radio system (GPRS) tunneling protocol user plane (GTP-U) tunnel, or the like.

In certain aspects, a signaling interface (or backhaul link) may be used between the source network entity 702a and the target network entity 702b for relaying the control plane and/or user plane traffic between the UE 704 and the source network entity 702a. The source network entity 702a may be in communication with the target network entity 702b via a signaling interface, such as an Xn interface. As shown, the CU-CP (CU-CP2) of the target network entity 702b may relay control plane traffic between the UE 704 and the CU-CP (CU-CP1) of the source network entity 702a via the signaling interface. The signaling interface may be or include, for example, Xn, X2, F1-C (which may be between the source CU and target DU) interface, or the like.

For downstream traffic (e.g., downlink traffic), a target DU (e.g., DU2) may obtain traffic from the source network entity 702a, and the target DU may forward the traffic to the UE. In some cases, a target CU may obtain traffic from the source network entity, and the target CU may forward the traffic to a target DU, which may then forward the traffic to the UE. For upstream traffic (e.g., uplink traffic), a target DU may obtain traffic from the UE, and the target DU may forward the traffic to the source network entity 702a. In some cases, a target DU may obtain traffic from the UE, and the target DU may forward the traffic to the target CU, which may then forward the traffic to the source network entity.

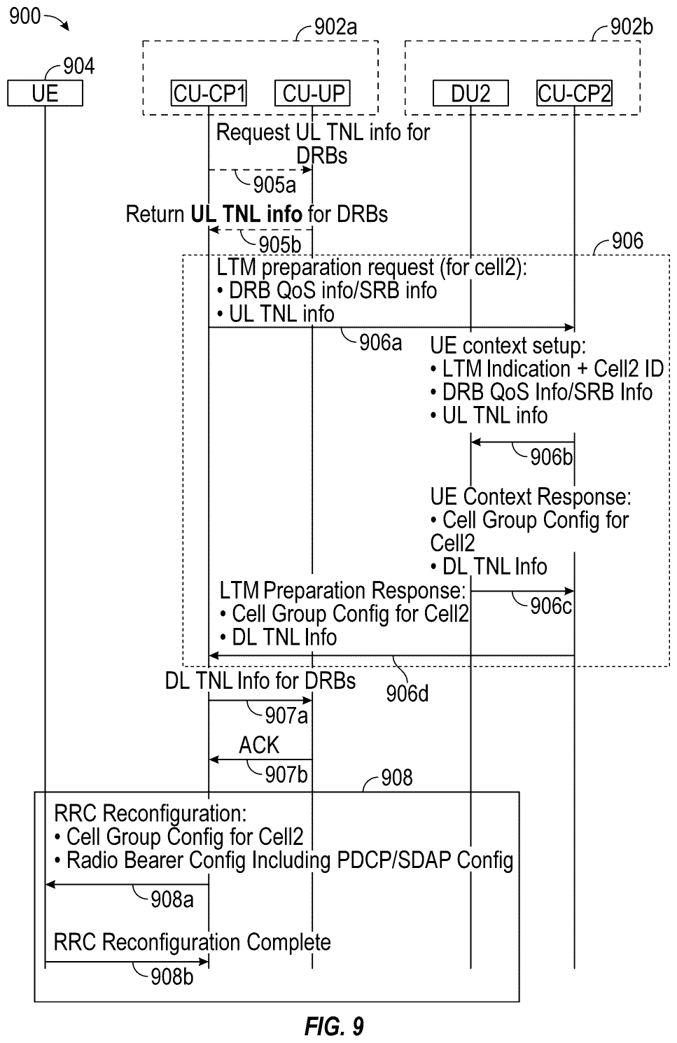

To facilitate the user plane traffic and/or control plane traffic routing via the target network entity 702b, the source network entity 702a and the target network entity 702b may exchange transport layer information, for example, as further described herein with respect to FIG. 9. The source network entity 702a and the target network entity 702b may establish one or more transport path(s) for routing the user plane traffic and/or the control plane traffic based on the transport layer information. The transport layer information may include, for example, a transport layer address (e.g., an IP address and/or domain name) of the source network entity 702a, a transport layer address of the target network entity 702b, a tunnel endpoint identity (ID) of the source network entity 702a, a tunnel endpoint ID of the target network entity 702b, QoS mapping information (e.g., a differentiated services code point (DSCP), flow label, etc.) of internet protocol (IP) packet(s) communicated via a tunnel, a port number, a protocol type, a cell group ID, a radio bearer ID, a QoS flow ID, QoS information of a radio bearer, a slice ID, an RLC mode (e.g., transparent mode, unacknowledged mode, and/or acknowledged mode), a PDCP packet sequence number (SN) length, or any combination thereof. In certain aspects, the second configuration discussed above may indicate or include the transport layer information. In certain aspects, the transport layer information may be exchanged among the disaggregated network entities of the source network entity 702a and/or the target network entity 702b, such as between the CU-CPI and the CU-UP of the source network entity 702a, and between the CU-CPI of the source network entity 702a and the CU-CP2 of the target network entity 702b, and/or between the CU-CP2 and the DU2 of the target network entity 702b.

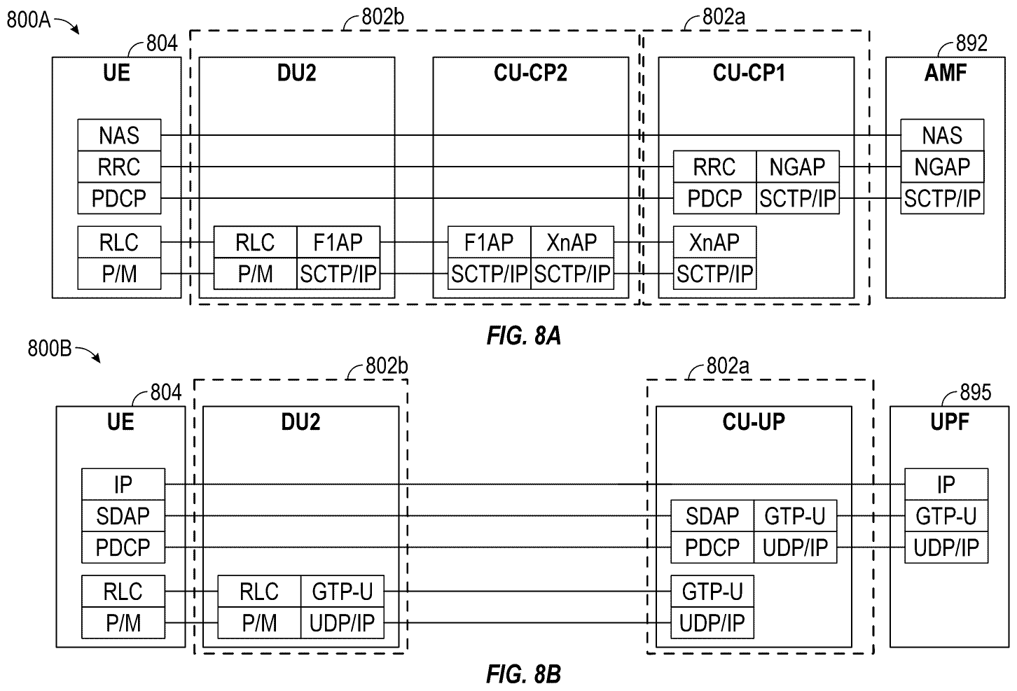

FIGS. 8A and 8B depict example protocol stacks 800A, 800B for anchored inter-network entity mobility. In this example, the protocol stacks 800A, 800B are distributed among a source network entity 802a (e.g., the source network entity 702a) and a target network entity 802b (e.g., the target network entity 702b). Any of the source network entity 802a and the target network entity 802b may be or include a disaggregated network entity, for example, as described herein with respect to FIG. 2. As an example, the source network entity 802a may include a source CU control plane entity (CU-CP1) and/or a source CU user plane entity (CU-UP). The target network entity 802b may include a target DU (DU2) and/or a target CU CP entity (CU-CP2). The anchored scheme for the protocol stacks 800A, 800B may be used when a UE performs a cell switch to a candidate cell served by the target network entity 802b, for example, during the second phase 703 of FIG. 7. The anchored scheme for the protocol stacks 800A, 800B may enable, for a mobility operation, reduced latencies, interruption times, packet losses, handover failures, and/or ping-ponging between network entities.

During a preparation phase (e.g., the first phase 701 of FIG. 7), the UE 804 may be configured with parameter(s) that enable communications via the distributed or anchored protocol stacks 800A, 800B as discussed herein with respect to FIG. 7. The UE 804 may obtain, from the source network entity 802a, lower layer configuration(s) for communications via the second cell at the RLC layer, MAC layer, and/or PHY layer associated with the anchored upper layer configuration(s) for the PDCP layer, SDAP layer, and/or RRC layer. The lower layer configuration(s) may include, for example, a cell group configuration and/or an RLC bearer configuration, and the corresponding anchored upper layer configuration(s) may include a radio bearer configuration. The lower layer configuration(s) and the upper layer configuration(s) may refer to a list of radio bearer identities that map the lower layer configuration(s) to the upper layer configuration(s). The target network entity 802b may send, to the source network entity 802a, the lower layer configurations for communications via the second cell. For example, the target network entity 802b may send, to the source network entity 802a, a list of radio bearer identities for lower layer (e.g., the RLC layer, MAC layer, and/or PHY layer) communications with the target network entity 802b via the second cell. The source network entity 802a may send, to the UE 804, the list of radio bearer identities for the lower layer communications with the target network entity 802b via the second cell.

Referring to FIG. 8A, the protocol stack 800A is an example of a control plane protocol stack distributed among the source network entity 802a and the target network entity 802b. In this example, the control plane traffic communicated between the source network entity 802a and the target network entity 802b may be communicated via a signaling interface, such as Xn, X2, F1-C interface, or the like, for example, as depicted in FIG. 7. The source network entity 802a may serve as a termination or anchor point for at least the RRC layer and/or the PDCP layer for control plane traffic between the UE 804 and the source network entity 802a. The UE may use the same control plane traffic session (e.g., RRC connection) established with the source network entity 802a for communications with the target network entity 802b, and the target network entity 802b may relay control plane traffic between the UE 804 and the source network entity 802a for the RRC layer and/or the PDCP layer. In certain aspects, the control traffic between the UE 804 and the source network entity 802a for the PDCP layer may be protected based on a security key and/or security algorithm established with the source network entity 802a. Accordingly, the target network entity 802b may request assistance from the source network entity 802a to modify, add, or release any certain configuration(s) at the UE 804, such as RRC configuration(s). The source network entity 802a may relay control plane traffic between the UE 804 and the AMF 892 for the NAS layer.

With respect to FIG. 8B, the protocol stack 800B is an example of a user plane protocol stack distributed among the source network entity 802a and the target network entity 802b. In this example, the user plane traffic communicated between the source network entity 802a and the target network entity 802b may be communicated via a tunnel, such as a F1-U, Xn-U, GTP-U tunnel, or the like, for example, as depicted in FIG. 7. The source network entity 802a may serve as a termination or anchor point for at least the SDAP layer and/or the PDCP layer for user plane traffic between the UE 804 and the source network entity 802a. The UE may use the same user plane traffic session (e.g., PDU session) established with the source network entity 802a for communications with the target network entity 802b, and the target network entity 802b may relay user plane traffic between the UE 804 and the source network entity 802a for the SDAP layer and/or the PDCP layer. The source network entity 802a may relay or route user plane traffic between the UE 804 and the UPF 895 for the IP or application layer.

Example Signaling for Anchored Inter-Network Entity Mobility

FIG. 9 depicts a process flow 900 for anchored inter-network entity mobility preparation among a first network entity 902a, a second network entity 902b, and a user equipment (UE) 904. In some aspects, the network entity 902a, 902b may be an example of the BS 102 depicted and described with respect to FIGS. 1 and 3 or a disaggregated base station depicted and described with respect to FIG. 2. For example, the first network entity 902a may include a CU-CP entity (CU-CP1) and a CU-UP entity (CU-UP); and the second network entity 902b may include a DU (DU2) and a CU-CP entity (CU-CP2). Similarly, the UE 904 may be an example of UE 104 depicted and described with respect to FIGS. 1 and 3. However, in other aspects, UE 904 may be another type of wireless communications device and network entity 902a, 902b may be another type of network entity or network node, such as those described herein.

In certain aspects, the first network entity 902a may be an example of the source network entity 702a, and the second network entity 902b may be an example of the target network entity 702b. For example, the first network entity 902a may communicate via or serve at least a first cell, and the second network entity 902b may communicate via or serve at least a second cell.

In certain cases, at 905a, the CU-CP of the first network entity 902a may request transport layer information (e.g., uplink tunnel information) from the CU-UP of the first network entity 902a, and at 905b, the CU-UP of the first network entity 902a may send transport layer information to the CU-CP of the first network entity 902a. The transport layer information may be or include tunneling information for uplink communications via data radio bearer(s) of the first network entity 902a. For example, the transport layer information may include the IP address of the CU-UP of the first network entity 902a.

At 906, the first network entity 902a obtains certain assistance information from the second network entity 902b. As an example, at 906a, the first network entity 902a sends, to the second network entity 902b, a mobility preparation request (e.g., an LTM preparation request) for a cell switch to the second cell (cell2) served at or by the second network entity 902b. The request may indicate for the second network entity 902b to provide assistance information for a cell switch to the second cell, where the user plane traffic session and/or the control plane traffic session for the UE 904 are anchored at or with the first network entity 902a as discussed herein. The cell switch may be from the first cell of the first network entity to the second network entity and/or from a third cell of a third network entity to the second network entity. In certain aspects, the request may include transport layer information for relaying user plane traffic and/or control plane traffic between the first network entity 902a and the UE 904, as discussed above. As an example, the request may include information associated with radio bearer(s) (e.g., DRB(s) and/or SRB(s)) for communications with the first network entity 902a and/or tunneling information for uplink communications via the second cell (e.g., a transport layer address of the first network entity 902a). In some cases, the request may include QoS specification(s) for the radio bearer(s).

In certain cases, at 906b, the CU-CP of the second network entity 902b may send, to the DU of the second network entity 902b, a UE context setup message, which may indicate or include the mobility preparation request for the second cell. In certain aspects, the UE context setup message may indicate or include the transport layer information for communications with the first network entity 902a. At 906c, the CU-CP of the second network entity 902b may obtain, from the DU of the second network entity 902b, a UE context response message. The response may indicate or include certain transport layer information associated with the second network entity 902b, such as tunneling information for downlink communications via the second cell (e.g., a transport layer address of the second network entity 902b). The response may indicate or include certain parameter(s) for communications via the second cell of the second network entity 902b, such as a cell group configuration for the second cell.

At 906d, the first network entity 902a obtains, from the second network entity 902b, a response to the mobility preparation request. The response may be or include an acknowledgement of the mobility preparation request. The response may be or include the assistance information for configuring a mobility operation at the UE 904 that enables a cell switch to the second cell of the second network entity 902b. The response may indicate or include certain parameter(s) for communications via the second cell of the second network entity 902b, such as the cell group configuration for the second cell. For example, the response may include the second configuration as discussed above with respect to FIG. 7. In certain aspects, the second configuration may indicate or include parameter(s) based on the information obtained from the first network entity 902a, for example, via the request.

In certain cases, at 907a, the CU-CP of the first network entity 902a may send, to the CU-UP of the first network entity 902a, transport layer information associated with the second network entity 902b, such as tunneling information for downlink communications via radio bearer(s). At 907b, the CU-CP of the first network entity 902a may obtain, from the CU-UP of the first network entity 902a, an acknowledgment (ACK) of the transport layer information.

At 908, the UE 904 obtains certain configuration(s) associated with an anchored inter-network entity mobility operation (e.g., an anchored intern-network entity LTM handover). At 908a, the UE 904 obtains, from the first network entity 902a, one or more configurations for the mobility operation for a cell switch to the second cell and/or for communications via the second cell of the second network entity 902b. The configuration(s) may establish a user plane traffic session (e.g., a PDU session and/or data radio bearer(s) for the PDU session) and/or a control plane traffic session (e.g., an RRC connection) between the UE 904 and the first network entity 902a. In certain aspects, the configuration(s) may indicate the user plane traffic session and/or control plane traffic session for the UE 904. For example, the one or more configurations may include the first configuration and/or the second configuration as discussed above with respect to FIG. 7. In certain aspects, an RRC reconfiguration message may indicate or include the configuration(s). In certain aspects, the configuration(s) may indicate or include an LTM configuration for anchored inter-network entity mobility. In certain cases, at 908b, the UE 904 may send, to the first network entity 902a, an RRC reconfiguration complete message.

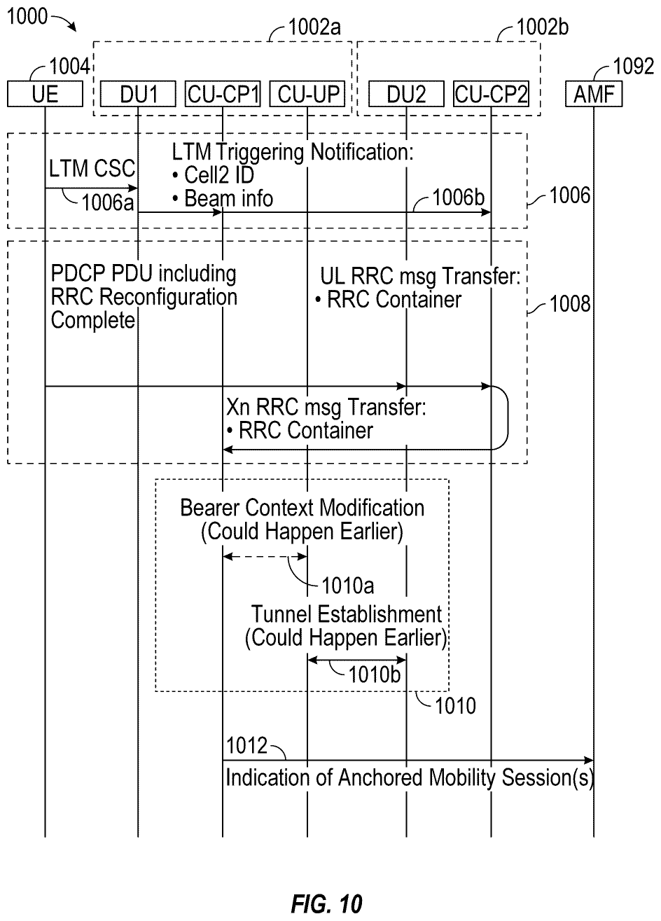

FIG. 10 depicts a process flow 1000 for a cell switch for anchored inter-network entity mobility among a first network entity 1002a, a second network entity 1002b, a third network entity 1092, and a user equipment (UE) 1004. In some aspects, the network entity 1002a, 1002b may be an example of the BS 102 depicted and described with respect to FIGS. 1 and 3 or a disaggregated base station depicted and described with respect to FIG. 2. For example, the first network entity 1002a may include a DU (DU1), a CU-CP entity (CU-CP1), and a CU-UP entity (CU-UP); and the second network entity 1002b may include a DU (DU2) and a CU-CP entity (CU-CP2). The third network entity 1092 may be an example of the AMF 192 of FIG. 1. Similarly, the UE 1004 may be an example of UE 104 depicted and described with respect to FIGS. 1 and 3. However, in other aspects, UE 1004 may be another type of wireless communications device, and the network entity 1002a, 1102b, 1092 may be another type of network entity or network node, such as those described herein.

In certain aspects, the first network entity 1002a may be an example of the source network entity 702a, and the second network entity 1002b may be an example of the target network entity 702b. For example, the first network entity 1002a may communicate via or serve at least a first cell, and the second network entity 1002b may communicate via or serve at least a second cell. The UE 1004 may obtain configuration(s) for an anchored mobility operation and/or communications via the second cell, for example, as discussed herein with respect to FIG. 9.

At 1006, a cell switch command may be received at the UE 1004, and a cell switch triggering notification is received at the second network entity 1002b. At 1006a, the UE 1004 obtains, from the first network entity 1002a, an indication to perform the mobility operation, such as an LTM cell switch to the second cell of the second network entity 1002b. For example, the indication may be or include an LTM cell switch command (CSC). The indication may trigger the UE 1004 to apply (e.g., activate or enable) the configuration(s) for communications via the second cell, for example, as discussed herein with respect to FIGS. 7 and 9. In certain aspects, at 1006b, the first network entity 1002a may notify the second network entity 1002b that the mobility operation has been triggered at the UE 1004. For example, the first network entity 1002a may send, to the second network entity 1002b, an indication that the target for the mobility operation is the second cell (e.g., based on cell identity of the second cell) and/or an indication of beamforming information for communications with the UE 1004 (e.g., an SSB associated with the second cell).

At 1008, the UE 1004 sends, to the second network entity 1002b, an indication of completion of the mobility operation for the cell switch to the second cell. The indication may include a RRC reconfiguration complete message. The UE 1004 may send the indication via the user plane traffic session and/or control plane traffic session established with the first network entity 1002a. In certain aspects, the second network entity 1002b may forward the indication to the first network entity 1002a, for example, via a signaling interface (e.g., an Xn interface) and/or a control plane tunnel (e.g., a GTP tunnel), for example, between the source CP and the target DU and/or between the source CP and the target CP.

At 1010, the first network entity 1002a may apply a bearer context modification to user plane traffic between the UE 1004 and the first network entity 1002a. For example, at 1010a, the CU-CP entity of the first network entity 1002a may notify the CU-CP entity of the first network entity 1002a the bearer context modification. At 1010b, the first network entity 1002a may establish a communication tunnel with the second network entity 1002b. For example, the first network entity 1002a may activate data forwarding for the user plane traffic session and/or control plane traffic session of the UE 1004. The first network entity 1002a may route traffic for the UE 1004 to the second network entity 1002b, and the second network entity 1002b may route traffic obtained from the UE 1004 to the first network entity 1002a. The data forwarding activation and/or tunnel establishment between the first network entity 1002a and the second network entity 1002b may be performed before or after communication of the cell switch command. In some cases, the tunnel establishment between the first network entity 1002a and the second network entity 1002b may occur in response to exchanging the transport layer information (or tunneling information), for example, as discussed herein with respect to FIG. 9.

At 1012, the first network entity 1002a may send, to the third network entity 1092, an indication of anchored mobility session(s) for the UE 1004 via the second cell of the second network entity 1002b. For example, the first network entity 1002a may notify the third network entity 1092 that the UE 1004 is in communication with the second network entity 1002b via the second cell, and that the first network entity 1002a is the termination or anchor point for the user plane traffic session and/or control plane traffic session of the UE 1004.

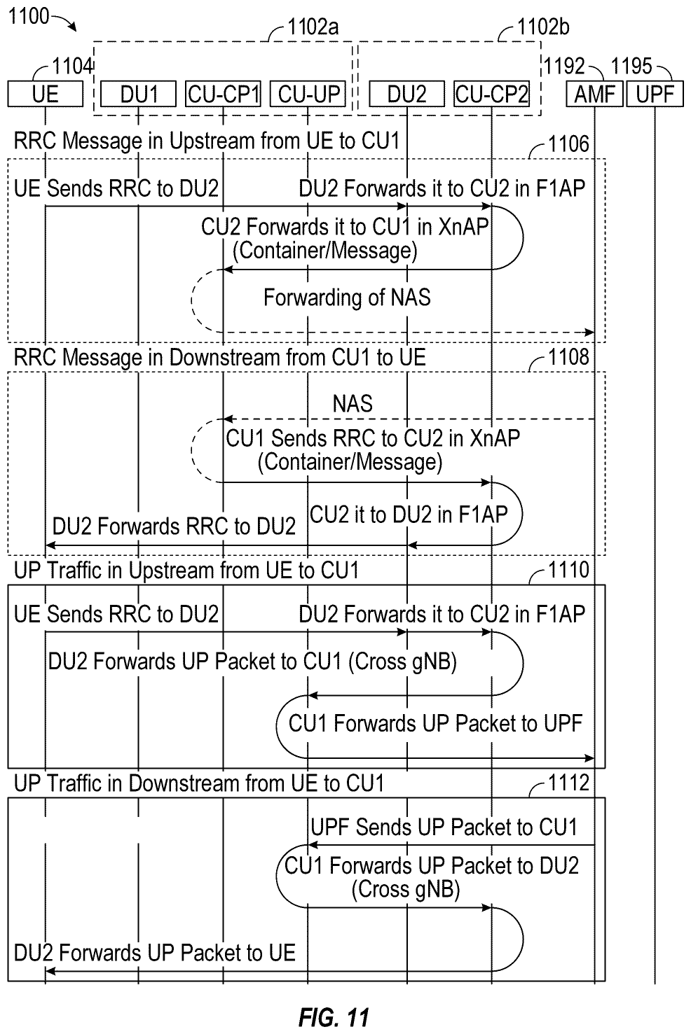

FIG. 11 depicts a process flow 1100 for traffic forwarding for anchored inter-network entity mobility among a first network entity 1102a, a second network entity 1102b, a third network entity 1192, a fourth network entity 1195, and a user equipment (UE) 1104. In some aspects, the network entity 1102a, 1102b may be an example of the BS 102 depicted and described with respect to FIGS. 1 and 3 or a disaggregated base station depicted and described with respect to FIG. 2. For example, the first network entity 1102a may include a DU (DUI), a CU-CP entity (CU-CP1) and a CU-UP entity (CU-UP); and the second network entity 1102b may include a DU (DU2) and a CU-CP entity (CU-CP2). The third network entity 1192 may be an example of the AMF 192 of FIG. 1; and the fourth network entity 1195 may be an example of the UPF 195 of FIG. 1. Similarly, the UE 1104 may be an example of UE 104 depicted and described with respect to FIGS. 1 and 3. However, in other aspects, UE 1104 may be another type of wireless communications device, and the network entity 1102a, 1102b, 1192, 1195 may be another type of network entity or network node, such as those described herein.

In certain aspects, the first network entity 1102a may be an example of the source network entity 702a, and the second network entity 1102b may be an example of the target network entity 702b. For example, the first network entity 1102a may communicate via or serve at least a first cell, and the second network entity 1102b may communicate via or serve at least a second cell. In this example, the UE 1104 may have performed the cell switch to the second cell, and the UE 1104 is engaged in communications with the first network entity 1102a via the second cell of the second network entity 1102b, for example, through the user plane traffic session and/or the control plane traffic session established with the first network entity 1102a. Note that the signaling depicted in FIG. 11 provides examples of user plane traffic being communicated between the DU of the second network entity 1102b and the CU of the first network entity 1102a via a tunnel and control plane traffic being communicated between the CU of the first network entity 1102a and the CU of the second network entity 1102b via a signaling interface. Aspects of the present disclosure may apply other suitable communication paths for user plane traffic and/or control plane traffic between the first network entity 1102a and the second network entity 1102b.

At 1106, the UE 1104 may send, to the first network entity 1102a, control plane traffic (e.g., an RRC message) via the second cell of the second network entity 1102b. For example, the UE 1104 may send, via the second cell, the control plane traffic to the second network entity 1102b, which forwards the control plane traffic to the first network entity 1102a. The UE 1104 may retain the control plane traffic session established with the first network entity 1102a to communicate via the second cell. In certain aspects, the first network entity 1102a may forward NAS message(s) from the UE 1104 to the AMF 1192.

At 1108, the UE 1104 may obtain, from the first network entity 1102a, control plane traffic (e.g., an RRC message) via the second cell of the second network entity 1102b. For example, the first network entity 1102a may send the control plane traffic to the second network entity 1102b, which forwards the control plane traffic to the UE 1104. In certain aspects, the first network entity 1102a forwards NAS message(s) from the third network entity 1192 to the UE 1104.

At 1110, the UE 1104 may send, to the first network entity 1102a, user plane traffic (e.g., a PDU packet) via the second cell of the second network entity 1102b. For example, the UE 1104 may send, via the second cell, the user plane traffic to the second network entity 1102b, which forwards the control plane traffic to the first network entity 1102a. In certain aspects, the first network entity 1102a may forward the user plane traffic to the fourth network entity 1195.

At 1112, the UE 1104 may obtain, from the first network entity 1102a, user plane traffic (e.g., a PDU packet) via the second cell of the second network entity 1102b. For example, the first network entity 1102a may send the user plane traffic to the second network entity 1102b, which forwards the user plane traffic to the UE 1104. In certain aspects, the first network entity 1102a may obtain the user plane traffic for the UE 1104 from the fourth network entity 1195, and the first network entity 1102a may forward the user plane traffic to the second network entity 1102b, which then forwards the user plane traffic to the UE 1104.

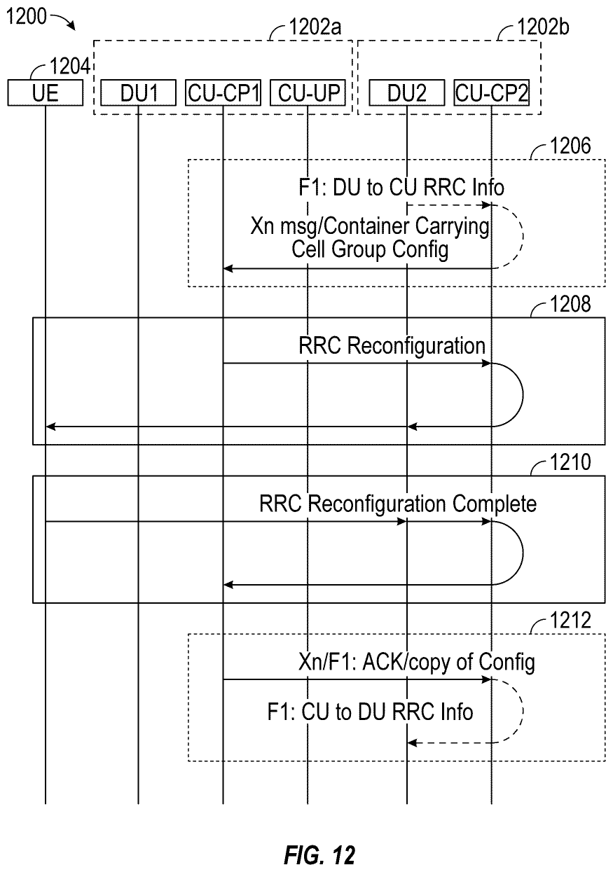

FIG. 12 depicts a process flow 1200 for modification of a UE configuration for anchored inter-network entity mobility among a first network entity 1202a, a second network entity 1202b, and a user equipment (UE) 1204. In some aspects, the network entity 1202a, 1202b may be an example of the BS 102 depicted and described with respect to FIGS. 1 and 3 or a disaggregated base station depicted and described with respect to FIG. 2. For example, the first network entity 1202a may include a DU (DUI), a CU-CP entity (CU-CP1) and a CU-UP entity (CU-UP); and the second network entity 1202b may include a DU (DU2) and a CU-CP entity (CU-CP2). Similarly, the UE 1204 may be an example of UE 104 depicted and described with respect to FIGS. 1 and 3. However, in other aspects, UE 1204 may be another type of wireless communications device, and the network entity 1202a, 1202b may be another type of network entity or network node, such as those described herein.

In certain aspects, the first network entity 1202a may be an example of the source network entity 702a, and the second network entity 1202b may be an example of the target network entity 702b. For example, the first network entity 1202a may communicate via or serve at least a first cell, and the second network entity 1202b may communicate via or serve at least a second cell. In this example, the UE 1204 may have performed the cell switch to the second cell, and the UE 1204 is engaged in communications with the first network entity 1202a via the second cell of the second network entity 1202b, for example, through the user plane traffic session and/or the control plane traffic session established with the first network entity 1202a.

At 1206, the first network entity 1202a may obtain, from the second network entity 1202b, a request for modification of the parameter(s) used for communications via the second cell. The request may indicate or include a modification to the cell group configuration associated with the second cell. For example, the request may indicate or include different bandwidth part(s) for communications via the second cell. In certain aspects, the request may indicate to release or deactivate the second cell for communications at the UE 1204.

At 1208, the first network entity 1202a may send, to the UE 1204, an indication of configuration(s) associated with the second cell based on the request. For example, the first network entity 1202a may include the requested modification(s) in the configuration(s). The first network entity 1202a may send the indication of the configuration(s) to the second network entity 1202b, which may then forward the indication to the UE 1204. The indication of the configuration(s) may include, for example, an RRC reconfiguration message. The indication of the configuration(s) may be security protected according to a security algorithm configuration established with the first network entity 1202a, and the second network entity 1202b may be unable to read the content of the indication of the configuration(s). In certain aspects, the indication of the configuration(s) may indicate to release or deactivate the second cell for communications at the UE 1204.

At 1210, the UE 1204 may send, to the first network entity 1202a, confirmation that the UE 1204 has applied to the configuration(s). For example, the UE 1204 may send the confirmation to the second network entity 1202b, which may then forward the confirmation to the first network entity 1202a. The confirmation may include, for example, an RRC reconfiguration complete message. The confirmation may be security protected according to a security algorithm configuration established with the first network entity 1202a, and the second network entity 1202b may be unable to read the content of the confirmation.

At 1212, the first network entity 1202a may notify the second network entity 1202b of the configuration(s) associated with the second cell applied at the UE 1204, for example, due to the security protection applied at 1208 and/or 1210. In certain aspects, the notification may include a copy of the RRC reconfiguration message sent to the UE 1204 at 1210.

Note that the mobility operations illustrated in FIGS. 9-12 are examples of anchored inter-network entity mobility triggered by an LTM cell switch command, and aspects of the present disclosure may be applied to any of other types mobility operations discussed herein, such as conditional LTM, L3 mobility, (conditional) serving cell modification or change, (conditional) serving cell addition, (conditional) serving cell release, DAPS handover, and/or dual connectivity. Note that the operations and signaling illustrated in FIGS. 9-12 are described herein to facilitate an understanding of anchored inter-network entity mobility, and aspects of the present disclosure may be performed in various manners via alternative or additional signaling and/or operations. In certain aspects, the operations and/or signaling of FIGS. 9-12 may occur in an order different from that described, and various actions may be added, omitted, or combined.

Example Operations for Anchored Inter-Network Entity Mobility

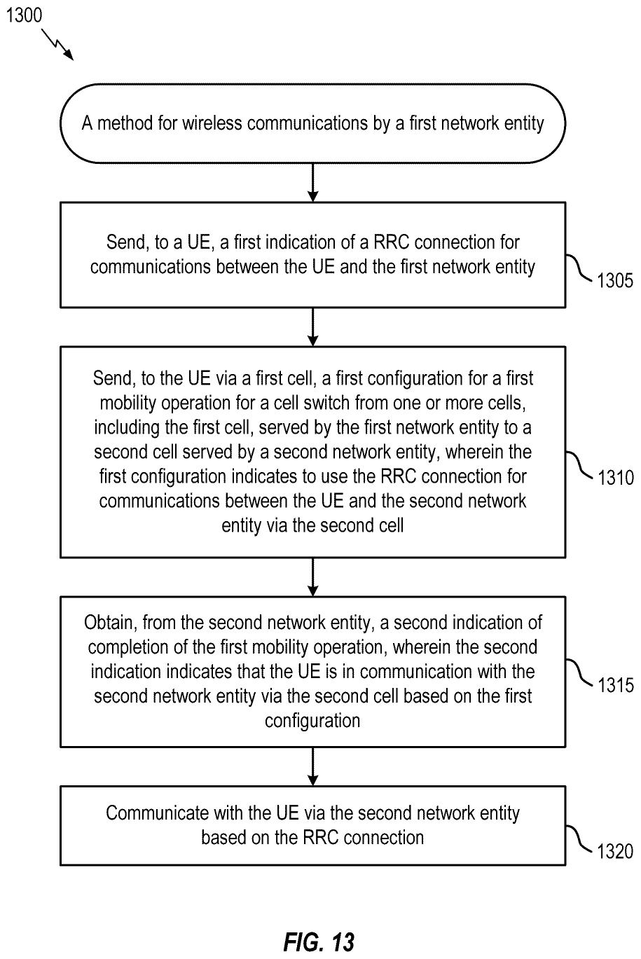

FIG. 13 shows a method 1300 for wireless communications by a first network entity, such as BS 102 of FIGS. 1 and 3, or a disaggregated base station as discussed with respect to FIG. 2. The first network entity may be an example of the source network entity 702a of FIG. 7.

Method 1300 begins at block 1305 with sending, to a UE, a first indication of a RRC connection for communications between the UE and the first network entity, for example, as described herein with respect to FIGS. 7-12.

Method 1300 then proceeds to block 1310 with sending, to the UE via a first cell, a first configuration for a first mobility operation for a cell switch from one or more cells, including the first cell, served by the first network entity to a second cell served by a second network entity, wherein the first configuration indicates to use the RRC connection for communications between the UE and the second network entity via the second cell, for example, as described herein with respect to FIGS. 7-12. The second network entity may be an example of the target network entity 702b of FIG. 7.

Method 1300 then proceeds to block 1315 with obtaining, from the second network entity, a second indication of completion of the first mobility operation, wherein the second indication indicates that the UE is in communication with the second network entity via the second cell based on the first configuration, for example, as described herein with respect to FIGS. 7-12.

Method 1300 then proceeds to block 1320 with communicating with the UE via the second network entity based on the RRC connection, for example, as described herein with respect to FIGS. 7-12.

In certain aspects, the first mobility operation comprises one or more of: a LTM operation; a conditional LTM operation; a Layer-3 mobility operation; a conditional handover; a conditional serving cell addition; a conditional serving cell change; a dual active protocol stack handover; or dual connectivity.

In certain aspects, method 1300 further includes obtaining, from the second network entity, a second configuration for communications between the UE and the second network entity via the second cell; and the first configuration is based on the second configuration.

In certain aspects, the second configuration includes a cell group configuration that indicates a cell group for communications between the UE and the second network entity, wherein the cell group comprises the second cell; and the first configuration includes the cell group configuration.

In certain aspects, method 1300 further includes sending, to the second network entity, a request for the second configuration for the first mobility operation; and obtaining the second configuration comprises obtaining, from the second network entity, acknowledgement of the request, wherein the acknowledgment comprises the second configuration.

In certain aspects, the acknowledgment indicates that the second network entity will (or is expected to) communicate with the UE via the second cell based on the RRC connection upon completion of the first mobility operation. In certain aspects, the acknowledgement indicates that the second network entity is successfully configured to communicate with the UE via the second cell based on the RRC connection upon completion of the first mobility operation.

In certain aspects, the first configuration indicates to use a same security key for communications via the first cell and for communications via the second cell.

In certain aspects, the first configuration indicates to use a same packet data convergence protocol entity for communications via the first cell and for communications via the second cell.

In certain aspects, the first configuration indicates to use a same service data adaptation protocol entity for communications via the first cell and for communications via the second cell.

In certain aspects, the first configuration indicates to use a same set of radio bearers for communications via the first cell and for communications via the second cell.

In certain aspects, method 1300 further includes sending, to the UE, a second configuration for a second mobility operation for a cell switch to a third cell served by at least one or more of the first network entity, the second network entity, or a third network entity, wherein the second configuration indicates to use the RRC connection for communications via the third cell.

In certain aspects, the second indication comprises a notification that the UE accessed the second cell.

In certain aspects, the second indication comprises a RRC reconfiguration complete message from the UE, wherein the RRC reconfiguration complete message indicates that the UE performed the first mobility operation based on the first configuration.

In certain aspects, block 1320 includes: sending first traffic to the UE via the second network entity; and obtaining second traffic from the UE via the second network entity.

In certain aspects, one or more of the first traffic or the second traffic comprises one or more of: control plane traffic; user plane traffic; a first packet of a radio bearer; or a second packet of a packet data convergence protocol.

In certain aspects, block 1315 includes obtaining the second indication based on the RRC connection.

In certain aspects, block 1320 includes: sending, to the second network entity, first traffic for the UE via a signaling interface between the first network entity and the second network entity; and obtaining, from the second network entity, second traffic from the UE via the signaling interface.

In certain aspects, block 1320 includes: sending, to the second network entity, first traffic for the UE via a communication tunnel between the first network entity and the second network entity; and obtaining, from the second network entity, second traffic from the UE via the communication tunnel.

In certain aspects, method 1300 further includes sending, to the second network entity, first transport layer information for uplink communications via the second cell.

In certain aspects, method 1300 further includes obtaining, from the second network entity, second transport layer information for downlink communications via the second cell, wherein the first configuration indicates one or more of the first transport layer information or the second transport layer information.

In certain aspects, method 1300 further includes sending, to the second network entity, first transport layer information associated with the first network entity.

In certain aspects, method 1300 further includes obtaining, from the second network entity, second transport layer information associated with the second network entity, wherein the first configuration indicates one or more of the first transport layer information or the second transport layer information.

In certain aspects, method 1300 further includes communicating transport layer information with the second network entity via a control plane entity of the first network entity.

In certain aspects, method 1300 further includes obtaining, from the second network entity, a request to modify the first configuration for communications between the UE and the second network entity via the second cell.

In certain aspects, method 1300 further includes sending, to the UE via the second network entity, a second configuration based on the request (e.g., in response to or after receiving the request).

In certain aspects, method 1300 further includes sending, to the second network entity, a third indication that the second configuration, which modifies the first configuration based on the request, has been sent to the UE.

In certain aspects, the third indication includes the second configuration.

In certain aspects, method 1300 further includes obtaining, from the second network entity, a request to deactivate the second cell for communications with the UE.

In certain aspects, method 1300 further includes sending, to the UE via the second network entity, an indication to deactivate the second cell.

In certain aspects, method 1300 further includes sending, to the second network entity, a third indication that the indication to deactivate the second cell has been sent to the UE.

In certain aspects, method 1300 further includes sending, to a third network entity, a third indication that the UE is in communication with the second network entity via the second cell based on the RRC connection between the UE and the first network entity.

In certain aspects, the third indication comprises one or more of: a cell identity for the second cell; a tracking area associated with the second network entity; an indication of the second network entity; or the second indication.

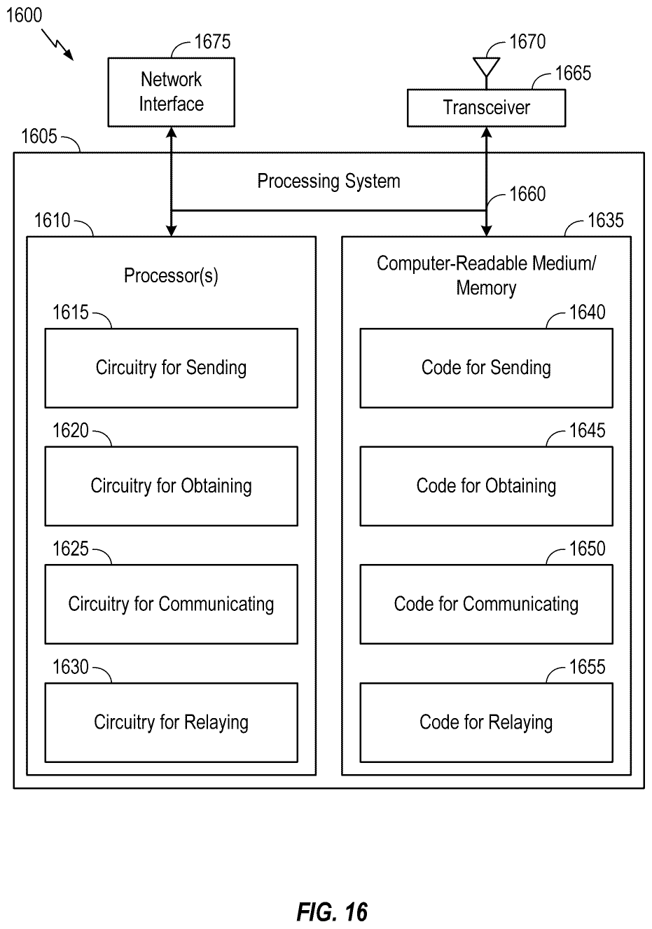

In certain aspects, method 1300, or any aspect related to it, may be performed by an apparatus, such as communications device 1600 of FIG. 16, which includes various components operable, configured, or adapted to perform the method 1300. Communications device 1600 is described below in further detail.

Note that FIG. 13 is just one example of a method, and other methods including fewer, additional, or alternative operations are possible consistent with this disclosure.

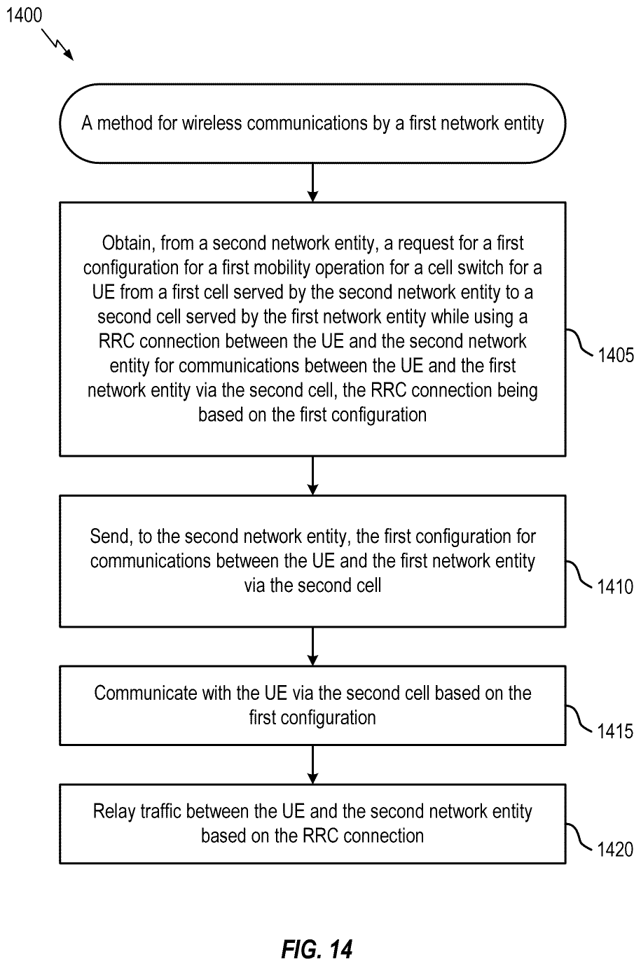

FIG. 14 shows a method 1400 for wireless communications by a first network entity, such as BS 102 of FIGS. 1 and 3, or a disaggregated base station as discussed with respect to FIG. 2. The first network entity may be an example of the target network entity 702b of FIG. 7.

Method 1400 begins at block 1405 with obtaining, from a second network entity, a request for a first configuration for a first mobility operation for a cell switch for a UE from a first cell served by the second network entity to a second cell served by the first network entity while using a RRC connection between the UE and the second network entity for communications between the UE and the first network entity via the second cell, the RRC connection being based on the first configuration, for example, as described herein with respect to FIGS. 7-12. The second network entity may be an example of the source network entity 702a of FIG. 7.

Method 1400 then proceeds to block 1410 with sending, to the second network entity, the first configuration for communications between the UE and the first network entity via the second cell, for example, as described herein with respect to FIGS. 7-12.

Method 1400 then proceeds to block 1415 with communicating with the UE via the second cell based on the first configuration, for example, as described herein with respect to FIGS. 7-12.

Method 1400 then proceeds to block 1420 with relaying traffic between the UE and the second network entity based on the RRC connection, for example, as described herein with respect to FIGS. 7-12.

In certain aspects, the first mobility operation comprises one or more of: a LTM operation; a conditional LTM operation; a Layer-3 mobility operation; a conditional handover; a conditional serving cell addition; a conditional serving cell change; a dual active protocol stack handover; or dual connectivity.

In certain aspects, the first configuration includes a cell group configuration that indicates a cell group for communications between the UE and the second network entity, wherein the cell group comprises the second cell.

In certain aspects, block 1410 includes sending, to the second network entity, acknowledgement of the request, wherein the acknowledgment comprises the first configuration.

In certain aspects, the acknowledgment indicates that the first network entity will (is expected to) communicate with the UE via the second cell based on the RRC connection upon completion of the first mobility operation. In certain aspects, the acknowledgement indicates that the first network entity is successfully configured to communicate with the UE via the second cell based on the RRC connection upon completion of the first mobility operation.

In certain aspects, the first configuration indicates to use a same security key for communications via the first cell and for communications via the second cell.

In certain aspects, the first configuration indicates to use a same packet data convergence protocol entity for communications via the first cell and for communications via the second cell.

In certain aspects, the first configuration indicates to use a same service data adaptation protocol entity for communications via the first cell and for communications via the second cell.

In certain aspects, the first configuration indicates to use a same set of radio bearers for communications via the first cell and for communications via the second cell.

In certain aspects, method 1400 further includes sending, to the second network entity, an indication of completion of the first mobility operation, where the UE is in communication with the first network entity via the second cell based on the first configuration.

In certain aspects, the indication comprises a notification that the UE accessed the second cell.

In certain aspects, the indication comprises a RRC reconfiguration complete message from the UE, wherein the RRC reconfiguration complete message indicates that the UE performed the first mobility operation based on the first configuration.

In certain aspects, sending the indication comprises sending the indication based on the RRC connection.

In certain aspects, block 1420 includes: obtaining first traffic from the second network entity; sending the first traffic to the UE; obtaining second traffic from the UE; and sending the second traffic to the second network entity.

In certain aspects, one or more of the first traffic or the second traffic comprises one or more of: control plane traffic; user plane traffic; a first packet of a radio bearer; or a second packet of a packet data convergence protocol.

In certain aspects, block 1420 includes: obtaining, from the second network entity, first traffic for the UE via a signaling interface between the first network entity and the second network entity; and sending, to the second network entity, second traffic from the UE via the signaling interface.

In certain aspects, block 1420 includes: obtaining, from the second network entity, first traffic for the UE via a communication tunnel between the first network entity and the second network entity; and sending, to the second network entity, second traffic from the UE via the communication tunnel.

In certain aspects, method 1400 further includes obtaining, from the second network entity, first transport layer information for uplink communications via the second cell.

In certain aspects, method 1400 further includes sending, to the second network entity, second transport layer information for downlink communications via the second cell, wherein the first configuration indicates one or more of the first transport layer information or the second transport layer information.

In certain aspects, method 1400 further includes obtaining, from the second network entity, first transport layer information associated with the first network entity.

In certain aspects, method 1400 further includes sending, to the second network entity, second transport layer information associated with the second network entity, wherein the first configuration indicates one or more of the first transport layer information or the second transport layer information.

In certain aspects, method 1400 further includes communicating transport layer information with the second network entity via a control plane entity of the first network entity.

In certain aspects, method 1400 further includes sending, to the second network entity, a request to modify the first configuration for communications between the UE and the second network entity via the second cell.

In certain aspects, method 1400 further includes obtaining, from the second network entity, a second configuration based on the request.

In certain aspects, method 1400 further includes sending, to the UE, the second configuration.

In certain aspects, method 1400 further includes obtaining, from the second network entity, an indication that the second configuration, which modifies the first configuration based on the request, has been sent to the UE.

In certain aspects, the indication includes the second configuration.

In certain aspects, method 1400 further includes sending, to the second network entity, a request to deactivate the second cell for communications with the UE.

In certain aspects, method 1400 further includes obtaining, from the second network entity, a first indication to deactivate the second cell.

In certain aspects, method 1400 further includes sending to the UE the first indication to deactivated the second cell.

In certain aspects, method 1400 further includes obtaining, from the second network entity, a second indication that the first indication to deactivate the second cell has been sent to the UE.

In certain aspects, the request comprises transport layer information for uplink communications via the second cell.

In certain aspects, the request comprises transport layer information associated with the second network entity.

In certain aspects, the first network entity comprises a first centralized unit and a first distributed unit that serves the second cell.

In certain aspects, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative operations are possible consistent with this disclosure.

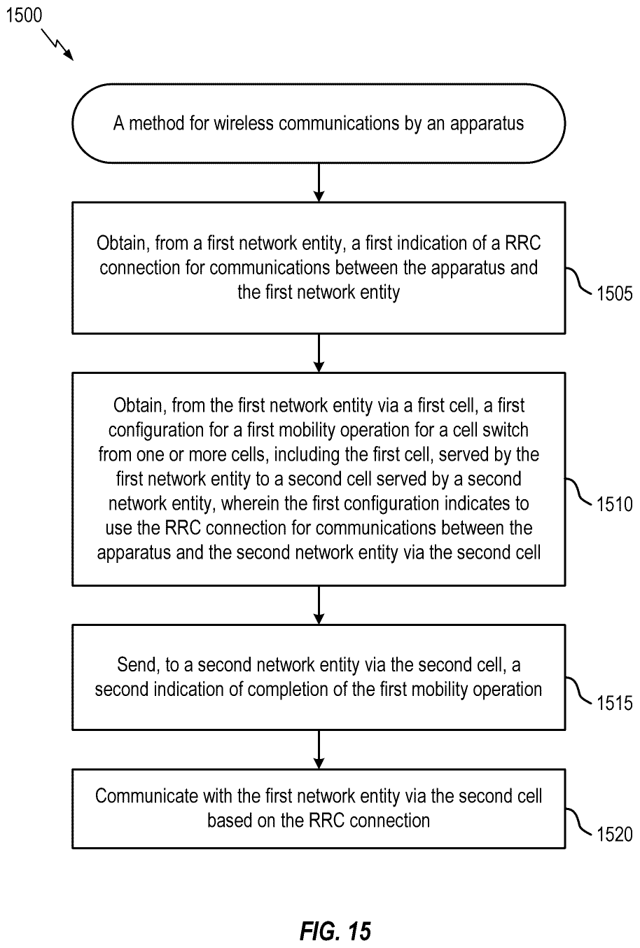

FIG. 15 shows a method 1500 for wireless communications by an apparatus, such as UE 104 of FIGS. 1 and 3.

Method 1500 begins at block 1505 with obtaining, from a first network entity, a first indication of a RRC connection for communications between the apparatus and the first network entity, for example, as described herein with respect to FIGS. 7-12. The first network entity may be an example of the source network entity 702a of FIG. 7.

Method 1500 then proceeds to block 1510 with obtaining, from the first network entity via a first cell, a first configuration for a first mobility operation for a cell switch from one or more cells, including the first cell, served by the first network entity to a second cell served by a second network entity, wherein the first configuration indicates to use the RRC connection for communications between the apparatus and the second network entity via the second cell, for example, as described herein with respect to FIGS. 7-12. The second network entity may be an example of the target network entity 702b of FIG. 7.

Method 1500 then proceeds to block 1515 with sending, to a second network entity via the second cell, a second indication of completion of the first mobility operation, for example, as described herein with respect to FIGS. 7-12.

Method 1500 then proceeds to block 1520 with communicating with the first network entity via the second cell based on the RRC connection, for example, as described herein with respect to FIGS. 7-12.

In certain aspects, the first mobility operation comprises one or more of: a LTM operation; a conditional LTM operation; a Layer-3 mobility operation; a conditional handover; a conditional serving cell addition; a conditional serving cell change; a dual active protocol stack handover; or dual connectivity.

In certain aspects, the first configuration includes a cell group configuration that indicates a cell group for communications between the apparatus and the second network entity, wherein the cell group comprises the second cell.

In certain aspects, the first configuration indicates to use a same security key for communications via the first cell and for communications via the second cell.

In certain aspects, the first configuration indicates to use a same packet data convergence protocol entity for communications via the first cell and for communications via the second cell.

In certain aspects, the first configuration indicates to use a same service data adaptation protocol entity for communications via the first cell and for communications via the second cell.

In certain aspects, the first configuration indicates to use a same set of radio bearers for communications via the first cell and for communications via the second cell.

In certain aspects, method 1500 further includes obtaining a second configuration for a second mobility operation for a cell switch to a third cell served by at least one or more of the apparatus, the second network entity, or a third network entity, wherein the second configuration indicates to use the RRC connection for communications via the third cell.

In certain aspects, the second indication comprises a notification that the apparatus accessed the second cell.

In certain aspects, the second indication comprises a RRC reconfiguration complete message from the apparatus, wherein the RRC reconfiguration complete message indicates that the apparatus performed the first mobility operation based on the first configuration.

In certain aspects, block 1520 includes: sending first traffic to the first network entity via second cell of the second network entity; and obtaining second traffic from the first network entity via the second cell of the second network entity.

In certain aspects, one or more of the first traffic or the second traffic comprises one or more of: control plane traffic; user plane traffic; a first packet of a radio bearer; or a second packet of a packet data convergence protocol.

In certain aspects, block 1515 includes sending the second indication based on the RRC connection.

In certain aspects, the first configuration indicates one or more of first transport layer information associated with the first network entity or second transport layer information associated with the second network entity.

In certain aspects, method 1500 further includes communicating transport layer information with the second network entity via a control plane entity of the apparatus.

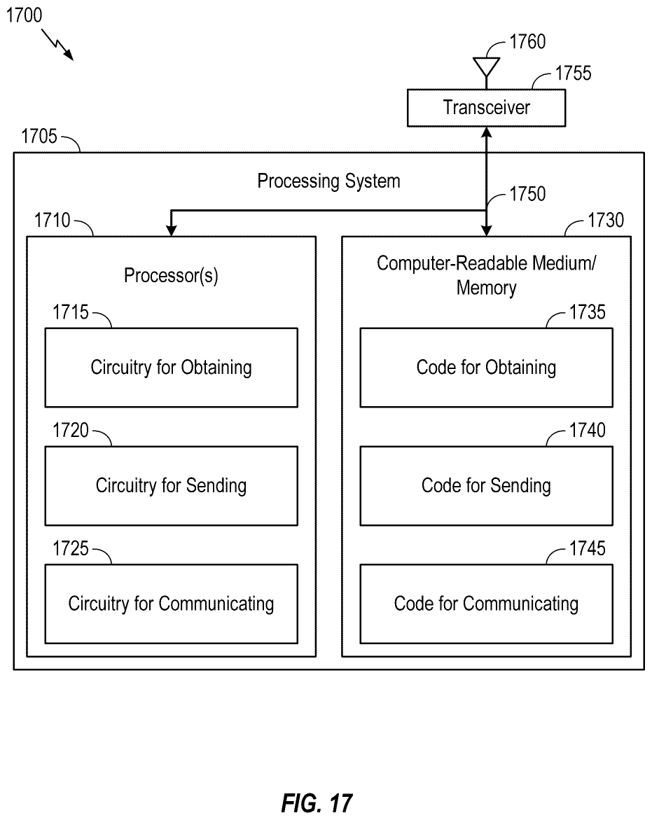

In certain aspects, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative operations are possible consistent with this disclosure.

### Example Communications Devices

FIG. 16 depicts aspects of an example communications device 1600. In some aspects, communications device 1600 is a network entity, such as BS 102 of FIGS. 1 and 3, or a disaggregated base station as discussed with respect to FIG. 2.

The communications device 1600 includes a processing system 1605 coupled to a transceiver 1665 (e.g., a transmitter and/or a receiver) and/or a network interface 1675. The transceiver 1665 is configured to transmit and receive signals for the communications device 1600 via an antenna 1670, such as the various signals as described herein. The network interface 1675 is configured to obtain and send signals for the communications device 1600 via communications link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1635 via a bus 1660. In certain aspects, the computer-readable medium/memory 1635 is configured to store instructions (e.g., computer-executable code) that when executed by the one or more processors 1610, enable and cause the one or more processors 1610 to perform the method 1300 described with respect to FIG. 13, or any aspect related to it, including any operations described in relation to FIG. 13; and the method 1400 described with respect to FIG. 14, or any aspect related to it, including any operations described in relation to FIG. 14. Note that reference to a processor of communications device 1600 performing a function may include one or more processors of communications device 1600 performing that function, such as in a distributed fashion.

In the depicted example, the computer-readable medium/memory 1635 stores code for sending 1640, code for obtaining 1645, code for communicating 1650, and code for relaying 1655. Processing of the code 1640-1655 may enable and cause the communications device 1600 to perform the method 1300 described with respect to FIG. 13, or any aspect related to it; and the method 1400 described with respect to FIG. 14, or any aspect related to it.

The one or more processors 1610 include circuitry configured to implement (e.g., execute) the code stored in the computer-readable medium/memory 1635, including circuitry for sending 1615, circuitry for obtaining 1620, circuitry for communicating 1625, and circuitry for relaying 1630. Processing with circuitry 1615-1630 may enable and cause the communications device 1600 to perform the method 1300 described with respect to FIG. 13, or any aspect related to it; and the method 1400 described with respect to FIG. 14, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1665, antenna 1670, and/or network interface 1675 of the communications device 1600 in FIG. 16, and/or one or more processors 1610 of the communications device 1600 in FIG. 16. Means for communicating, receiving or obtaining may include the transceivers 332, antenna(s) 334, receive processor 338, AI processor 318, and/or controller/processor 340 of the BS 102 illustrated in FIG. 3, transceiver 1665, antenna 1670, and/or network interface 1675 of the communications device 1600 in FIG. 16, and/or one or more processors 1610 of the communications device 1600 in FIG. 16.

FIG. 17 depicts aspects of an example communications device 1700. In some aspects, communications device 1700 is a user equipment, such as UE 104 described above with respect to FIGS. 1 and 3.

The communications device 1700 includes a processing system 1705 coupled to a transceiver 1755 (e.g., a transmitter and/or a receiver). The transceiver 1755 is configured to transmit and receive signals for the communications device 1700 via an antenna 1760, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. The one or more processors 1710 are coupled to a computer-readable medium/memory 1730 via a bus 1750. In certain aspects, the computer-readable medium/memory 1730 is configured to store instructions (e.g., computer-executable code) that when executed by the one or more processors 1710, enable and cause the one or more processors 1710 to perform the method 1500 described with respect to FIG. 15, or any aspect related to it, including any operations described in relation to FIG. 15. Note that reference to a processor performing a function of communications device 1700 may include one or more processors performing that function of communications device 1700, such as in a distributed fashion.

In the depicted example, computer-readable medium/memory 1730 stores code for obtaining 1735, code for sending 1740, and code for communicating 1745. Processing of the code 1735-1745 may enable and cause the communications device 1700 to perform the method 1500 described with respect to FIG. 15, or any aspect related to it.

The one or more processors 1710 include circuitry configured to implement (e.g., execute) the code stored in the computer-readable medium/memory 1730, including circuitry for obtaining 1715, circuitry for sending 1720, and circuitry for communicating 1725. Processing with circuitry 1715-1725 may enable and cause the communications device 1700 to perform the method 1500 described with respect to FIG. 15, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1755 and/or antenna 1760 of the communications device 1700 in FIG. 17, and/or one or more processors 1710 of the communications device 1700 in FIG. 17. Means for communicating, receiving or obtaining may include the transceivers 354, antenna(s) 352, receive processor 358, AI processor 370, and/or controller/processor 380 of the UE 104 illustrated in FIG. 3, transceiver 1755 and/or antenna 1760 of the communications device 1700 in FIG. 17, and/or one or more processors 1710 of the communications device 1700 in FIG. 17.

### Example Clauses

Implementation examples are described in the following numbered clauses:
Clause 1: A method for wireless communications by a first network entity comprising: sending, to a UE, a first indication of a RRC connection for communications between the UE and the first network entity; sending, to the UE via a first cell, a first configuration for a first mobility operation for a cell switch from one or more cells, including the first cell, served by the first network entity to a second cell served by a second network entity, wherein the first configuration indicates to use the RRC connection for communications between the UE and the second network entity via the second cell; obtaining, from the second network entity, a second indication of completion of the first mobility operation, where the UE is in communication with the second network entity via the second cell based on the first configuration; and communicating with the UE via the second network entity based on the RRC connection.
Clause 2: The method of Clause 1, wherein the first mobility operation comprises one or more of: a LTM operation; a conditional LTM operation; a Layer-3 mobility operation; a conditional handover; a conditional serving cell addition; a conditional serving cell change; a dual active protocol stack handover; or dual connectivity.
Clause 3: The method of any one of Clauses 1-2, further comprising obtaining, from the second network entity, a second configuration for communications between the UE and the second network entity via the second cell; and the first configuration is based on the second configuration.
Clause 4: The method of Clause 3, wherein: the second configuration includes a cell group configuration that indicates a cell group for communications between the UE and the second network entity, wherein the cell group comprises the second cell; and the first configuration includes the cell group configuration.
Clause 5: The method of Clause 3, further comprising sending, to the second network entity, a request for the second configuration for the first mobility operation; and obtaining the second configuration comprises obtaining, from the second network entity, acknowledgement of the request, wherein the acknowledgment comprises the second configuration.
Clause 6: The method of Clause 5, wherein the acknowledgment indicates that the second network entity will communicate with the UE via the second cell based on the RRC connection upon completion of the first mobility operation.
Clause 7: The method of any one of Clauses 1-6, wherein the first configuration indicates to use a same security key for communications via the first cell and for communications via the second cell.
Clause 8: The method of any one of Clauses 1-7, wherein the first configuration indicates to use a same packet data convergence protocol entity for communications via the first cell and for communications via the second cell.
Clause 9: The method of any one of Clauses 1-8, wherein the first configuration indicates to use a same service data adaptation protocol entity for communications via the first cell and for communications via the second cell.
Clause 10: The method of any one of Clauses 1-9, wherein the first configuration indicates to use a same set of radio bearers for communications via the first cell and for communications via the second cell.
Clause 11: The method of any one of Clauses 1-10, further comprising sending, to the UE, a second configuration for a second mobility operation for a cell switch to a third cell served by at least one or more of the first network entity, the second network entity, or a third network entity, wherein the second configuration indicates to use the RRC connection for communications via the third cell.
Clause 12: The method of any one of Clauses 1-11, wherein the second indication comprises a notification that the UE accessed the second cell.
Clause 13: The method of any one of Clauses 1-12, wherein the second indication comprises a RRC reconfiguration complete message from the UE, wherein the RRC reconfiguration complete message indicates that the UE performed the first mobility operation based on the first configuration.
Clause 14: The method of any one of Clauses 1-13, wherein communicating with the UE comprises: sending first traffic to the UE via the second network entity; and obtaining second traffic from the UE via the second network entity.
Clause 15: The method of Clause 14, wherein one or more of the first traffic or the second traffic comprises one or more of: control plane traffic; user plane traffic; a first packet of a radio bearer; or a second packet of a packet data convergence protocol.
Clause 16: The method of any one of Clauses 1-15, wherein obtaining the second indication comprises obtaining the second indication based on the RRC connection.
Clause 17: The method of any one of Clauses 1-16, wherein communicating with the UE comprises: sending, to the second network entity, first traffic for the UE via a signaling interface between the first network entity and the second network entity; and obtaining, from the second network entity, second traffic from the UE via the signaling interface.
Clause 18: The method of any one of Clauses 1-17, wherein communicating with the UE comprises: sending, to the second network entity, first traffic for the UE via a communication tunnel between the first network entity and the second network entity; and obtaining, from the second network entity, second traffic from the UE via the communication tunnel.
Clause 19: The method of any one of Clauses 1-18, further comprising: sending, to the second network entity, first transport layer information for uplink communications via the second cell; and obtaining, from the second network entity, second transport layer information for downlink communications via the second cell, wherein the first configuration indicates one or more of the first transport layer information or the second transport layer information.
Clause 20: The method of any one of Clauses 1-19, further comprising: sending, to the second network entity, first transport layer information associated with the first network entity; and obtaining, from the second network entity, second transport layer information associated with the second network entity, wherein the first configuration indicates one or more of the first transport layer information or the second transport layer information.
Clause 21: The method of any one of Clauses 1-20, further comprising communicating transport layer information with the second network entity via a control plane entity of the first network entity.
Clause 22: The method of any one of Clauses 1-21, further comprising: obtaining, from the second network entity, a request to modify the first configuration for communications between the UE and the second network entity via the second cell; and sending, to the UE via the second network entity, a second configuration based on the request.
Clause 23: The method of Clause 22, further comprising sending, to the second network entity, a third indication that the second configuration, which modifies the first configuration based on the request, has been sent to the UE.
Clause 24: The method of Clause 23, wherein the third indication includes the second configuration.
Clause 25: The method of any one of Clauses 1-24, further comprising: obtaining, from the second network entity, a request to deactivate the second cell for communications with the UE; and sending, to the UE via the second network entity, an indication to deactivate the second cell.
Clause 26: The method of Clause 25, further comprising sending, to the second network entity, a third indication that the indication to deactivate the second cell has been sent to the UE.
Clause 27: The method of any one of Clauses 1-26, further comprising sending, to a third network entity, a third indication that the UE is in communication with the second network entity via the second cell based on the RRC connection between the UE and the first network entity.
Clause 28: The method of Clause 27, wherein the third indication comprises one or more of: a cell identity for the second cell; a tracking area associated with the second network entity; an indication of the second network entity; or the second indication.
Clause 29: A method for wireless communications by a first network entity comprising: obtaining, from a second network entity, a request for a first configuration for a first mobility operation for a cell switch for a UE from a first cell served by the second network entity to a second cell served by the first network entity while using a RRC connection between the UE and the second network entity for communications between the UE and the first network entity via the second cell, the RRC connection being based on the first configuration; sending, to the second network entity, the first configuration for communications between the UE and the first network entity via the second cell; communicating with the UE via the second cell based on the first configuration; and relaying traffic between the UE and the second network entity based on the RRC connection.
Clause 30: The method of Clause 29, wherein the first mobility operation comprises one or more of: a LTM operation; a conditional LTM operation; a Layer-3 mobility operation; a conditional handover; a conditional serving cell addition; a conditional serving cell change; a dual active protocol stack handover; or dual connectivity.
Clause 31: The method of any one of Clauses 29-30, wherein the first configuration includes a cell group configuration that indicates a cell group for communications between the UE and the second network entity, wherein the cell group comprises the second cell.
Clause 32: The method of any one of Clauses 29-31, wherein sending the first configuration comprises sending, to the second network entity, acknowledgement of the request, wherein the acknowledgment comprises the first configuration.
Clause 33: The method of Clause 32, wherein the acknowledgment indicates that the first network entity will communicate with the UE via the second cell based on the RRC connection upon completion of the first mobility operation.
Clause 34: The method of any one of Clauses 29-33, wherein the first configuration indicates to use a same security key for communications via the first cell and for communications via the second cell.
Clause 35: The method of any one of Clauses 29-34, wherein the first configuration indicates to use a same packet data convergence protocol entity for communications via the first cell and for communications via the second cell.
Clause 36: The method of any one of Clauses 29-35, wherein the first configuration indicates to use a same service data adaptation protocol entity for communications via the first cell and for communications via the second cell.
Clause 37: The method of any one of Clauses 29-36, wherein the first configuration indicates to use a same set of radio bearers for communications via the first cell and for communications via the second cell.
Clause 38: The method of any one of Clauses 29-37, further comprising sending, to the second network entity, an indication of completion of the first mobility operation, where the UE is in communication with the first network entity via the second cell based on the first configuration.
Clause 39: The method of Clause 38, wherein the indication comprises a notification that the UE accessed the second cell.
Clause 40: The method of Clause 38, wherein the indication comprises a RRC reconfiguration complete message from the UE, wherein the RRC reconfiguration complete message indicates that the UE performed the first mobility operation based on the first configuration.
Clause 43: The method of Clause 38, wherein sending the indication comprises sending the indication based on the RRC connection.
Clause 41: The method of any one of Clauses 29-40, wherein relaying traffic comprises: obtaining first traffic from the second network entity; sending the first traffic to the UE; obtaining second traffic from the UE; and sending the second traffic to the second network entity.
Clause 42: The method of Clause 41, wherein one or more of the first traffic or the second traffic comprises one or more of: control plane traffic; user plane traffic; a first packet of a radio bearer; or a second packet of a packet data convergence protocol.
Clause 44: The method of any one of Clauses 29-43, wherein relaying traffic comprises: obtaining, from the second network entity, first traffic for the UE via a signaling interface between the first network entity and the second network entity; and sending, to the second network entity, second traffic from the UE via the signaling interface.
Clause 45: The method of any one of Clauses 29-44, wherein relaying traffic comprises: obtaining, from the second network entity, first traffic for the UE via a communication tunnel between the first network entity and the second network entity; and sending, to the second network entity, second traffic from the UE via the communication tunnel.
Clause 46: The method of any one of Clauses 29-45, further comprising: obtaining, from the second network entity, first transport layer information for uplink communications via the second cell; and sending, to the second network entity, second transport layer information for downlink communications via the second cell, wherein the first configuration indicates one or more of the first transport layer information or the second transport layer information.
Clause 47: The method of any one of Clauses 29-46, further comprising: obtaining, from the second network entity, first transport layer information associated with the first network entity; and sending, to the second network entity, second transport layer information associated with the second network entity, wherein the first configuration indicates one or more of the first transport layer information or the second transport layer information.
Clause 48: The method of any one of Clauses 29-47, further comprising communicating transport layer information with the second network entity via a control plane entity of the first network entity.
Clause 49: The method of any one of Clauses 29-48, further comprising: sending, to the second network entity, a request to modify the first configuration for communications between the UE and the second network entity via the second cell; obtaining, from the second network entity, a second configuration based on the request; and sending, to the UE, the second configuration.
Clause 50: The method of Clause 49, further comprising obtaining, from the second network entity, an indication that the second configuration, which modifies the first configuration based on the request, has been sent to the UE.
Clause 51: The method of Clause 50, wherein the indication includes the second configuration.
Clause 52: The method of any one of Clauses 29-51, further comprising: sending, to the second network entity, a request to deactivate the second cell for communications with the UE; obtaining, from the second network entity, a first indication to deactivate the second cell; and sending to the UE the first indication to deactivated the second cell.
Clause 53: The method of Clause 52, further comprising obtaining, from the second network entity, a second indication that the first indication to deactivate the second cell has been sent to the UE.
Clause 54: The method of any one of Clauses 29-53, wherein the request comprises transport layer information for uplink communications via the second cell.
Clause 55: The method of any one of Clauses 29-54, wherein the request comprises transport layer information associated with the second network entity.
Clause 56: The method of any one of Clauses 29-55, wherein the first network entity comprises a first centralized unit and a first distributed unit that serves the second cell
Clause 57: A method for wireless communications by an apparatus comprising: obtaining, from a first network entity, a first indication of a RRC connection for communications between the apparatus and the first network entity; obtaining, from the first network entity via a first cell, a first configuration for a first mobility operation for a cell switch from one or more cells, including the first cell, served by the first network entity to a second cell served by a second network entity, wherein the first configuration indicates to use the RRC connection for communications between the apparatus and the second network entity via the second cell; sending, to a second network entity via the second cell, a second indication of completion of the first mobility operation; and communicating with the first network entity via the second cell based on the RRC connection.
Clause 58: The method of Clause 57, wherein the first mobility operation comprises one or more of: a LTM operation; a conditional LTM operation; a Layer-3mobility operation; a conditional handover; a conditional serving cell addition; a conditional serving cell change; a dual active protocol stack handover; or dual connectivity.
Clause 59: The method of any one of Clauses 57-58, wherein the first configuration includes a cell group configuration that indicates a cell group for communications between the apparatus and the second network entity, wherein the cell group comprises the second cell.
Clause 60: The method of any one of Clauses 57-59, wherein the first configuration indicates to use a same security key for communications via the first cell and for communications via the second cell.
Clause 61: The method of any one of Clauses 57-60, wherein the first configuration indicates to use a same packet data convergence protocol entity for communications via the first cell and for communications via the second cell.
Clause 62: The method of any one of Clauses 57-61, wherein the first configuration indicates to use a same service data adaptation protocol entity for communications via the first cell and for communications via the second cell.
Clause 63: The method of any one of Clauses 57-62, wherein the first configuration indicates to use a same set of radio bearers for communications via the first cell and for communications via the second cell.
Clause 64: The method of any one of Clauses 57-63, further comprising obtaining a second configuration for a second mobility operation for a cell switch to a third cell served by at least one or more of the apparatus, the second network entity, or a third network entity, wherein the second configuration indicates to use the RRC connection for communications via the third cell.
Clause 65: The method of any one of Clauses 57-64, wherein the second indication comprises a notification that the apparatus accessed the second cell.
Clause 66: The method of any one of Clauses 57-65, wherein the second indication comprises a RRC reconfiguration complete message from the apparatus, wherein the RRC reconfiguration complete message indicates that the apparatus performed the first mobility operation based on the first configuration.
Clause 67: The method of any one of Clauses 57-66, wherein communicating with the first network entity comprises: sending first traffic to the first network entity via second cell of the second network entity; and obtaining second traffic from the first network entity via the second cell of the second network entity.
Clause 68: The method of Clause 67, wherein one or more of the first traffic or the second traffic comprises one or more of: control plane traffic; user plane traffic; a first packet of a radio bearer; or a second packet of a packet data convergence protocol.
Clause 69: The method of any one of Clauses 57-68, wherein sending the second indication comprises sending the second indication based on the RRC connection.
Clause 70: The method of any one of Clauses 57-69, wherein the first configuration indicates one or more of first transport layer information associated with the first network entity or second transport layer information associated with the second network entity.
Clause 71: The method of any one of Clauses 57-70, further comprising communicating transport layer information with the second network entity via a control plane entity of the apparatus.
Clause 72: One or more apparatuses, comprising: one or more memories comprising executable instructions; and one or more processors configured to execute the executable instructions and cause the one or more apparatuses to perform a method in accordance with any one of Clauses 1-71.
Clause 73: One or more apparatuses, comprising: one or more memories; and one or more processors, coupled to the one or more memories, configured to cause the one or more apparatuses to perform a method in accordance with any one of Clauses 1-71.

Clause 74: One or more apparatuses, comprising: one or more memories; and one or more processors, coupled to the one or more memories, configured to perform a method in accordance with any one of Clauses 1-71.
Clause 75: One or more apparatuses, comprising means for performing a method in accordance with any one of Clauses 1-71.
Clause 76: One or more non-transitory computer-readable media comprising executable instructions that, when executed by one or more processors of one or more apparatuses, cause the one or more apparatuses to perform a method in accordance with any one of Clauses 1-71.
Clause 77: One or more computer program products embodied on one or more computer-readable storage media comprising code for performing a method in accordance with any one of Clauses 1-71.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one or more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A first network entity configured for wireless communications, comprising:
one or more memories; and
one or more processors coupled to the one or more memories, the one or more processors being configured to cause the first network entity to:
send, to a user equipment (UE), a first indication of a radio resource control (RRC) connection for communications between the UE and the first network entity;
send, to the UE via a first cell, a first configuration for a first mobility operation for a cell switch to a second cell served by a second network entity, wherein the first configuration indicates to use the RRC connection for communications between the UE and the second network entity via the second cell;
obtain, from the second network entity, a second indication of completion of the first mobility operation, wherein the second indication indicates that the UE is in communication with the second network entity via the second cell based on the first configuration; and
communicate with the UE via the second network entity based on the RRC connection.

2. The first network entity of claim 1, wherein the first mobility operation comprises one or more of:
a lower-layer triggered mobility (LTM) operation;
a conditional LTM operation;
a Layer-3 mobility operation;
a conditional handover;
a conditional serving cell addition;
a conditional serving cell change;
a dual active protocol stack handover; or dual connectivity.

3. The first network entity of claim 1, wherein:
the one or more processors are configured to cause the first network entity to obtain, from the second network entity, a second configuration for communications between the UE and the second network entity via the second cell; and
the first configuration is based on the second configuration.

4. The first network entity of claim 3, wherein:
the second configuration includes a cell group configuration that indicates a cell group for communications between the UE and the second network entity, wherein the cell group comprises the second cell; and
the first configuration includes the cell group configuration.

5. The first network entity of claim 3, wherein:
the one or more processors are configured to cause the first network entity to send, to the second network entity, a request for the second configuration for the first mobility operation; and
to obtain the second configuration, the one or more processors are configured to cause the first network entity to obtain, from the second network entity, acknowledgement of the request, wherein the acknowledgment comprises the second configuration.

6. The first network entity of claim 5, wherein the acknowledgment indicates that the second network entity will communicate with the UE via the second cell based on the RRC connection upon completion of the first mobility operation.

7. The first network entity of claim 1, wherein the second indication comprises a notification that the UE accessed the second cell.

8. The first network entity of claim 1, wherein the second indication comprises a RRC reconfiguration complete message from the UE, wherein the RRC reconfiguration complete message indicates that the UE performed the first mobility operation based on the first configuration.

9. The first network entity of claim 1, wherein to communicate with the UE, the one or more processors are configured to cause the first network entity to:
send first traffic to the UE via the second network entity; and
obtain second traffic from the UE via the second network entity.

10. The first network entity of claim 1, wherein to obtain the second indication, the one or more processors are configured to cause the first network entity to obtain the second indication based on the RRC connection.

11. The first network entity of claim 1, wherein to communicate with the UE, the one or more processors are configured to cause the first network entity to:
send, to the second network entity, first traffic for the UE via a signaling interface between the first network entity and the second network entity; and
obtain, from the second network entity, second traffic from the UE via the signaling interface.

12. The first network entity of claim 1, wherein to communicate with the UE, the one or more processors are configured to cause the first network entity to:
send, to the second network entity, first traffic for the UE via a communication tunnel between the first network entity and the second network entity; and
obtain, from the second network entity, second traffic from the UE via the communication tunnel.

13. The first network entity of claim 1, wherein the one or more processors are configured to cause the first network entity to:
send, to the second network entity, first transport layer information for uplink communications via the second cell; and
obtain, from the second network entity, second transport layer information for downlink communications via the second cell, wherein the first configuration indicates one or more of the first transport layer information or the second transport layer information.

14. The first network entity of claim 1, wherein the one or more processors are configured to cause the first network entity to:
send, to the second network entity, first transport layer information associated with the first network entity; and
obtain, from the second network entity, second transport layer information associated with the second network entity, wherein the first configuration indicates one or more of the first transport layer information or the second transport layer information.

15. The first network entity of claim 1, wherein the one or more processors are configured to cause the first network entity to communicate transport layer information with the second network entity via a control plane entity of the first network entity.

16. The first network entity of claim 1, wherein the one or more processors are configured to cause the first network entity to:
obtain, from the second network entity, a request to modify the first configuration for communications between the UE and the second network entity via the second cell; and
send, to the UE via the second network entity, a second configuration based on the request.

17. The first network entity of claim 1, wherein the one or more processors are configured to cause the first network entity to:
obtain, from the second network entity, a request to deactivate the second cell for communications with the UE; and
send, to the UE via the second network entity, an indication to deactivate the second cell.

18. The first network entity of claim 1, wherein the one or more processors are configured to cause the first network entity to send, to a third network entity, a third indication that the UE is in communication with the second network entity via the second cell based on the RRC connection between the UE and the first network entity.

19. A first network entity configured for wireless communications, comprising:
one or more memories; and
one or more processors coupled to the one or more memories, the one or more processors being configured to cause the first network entity to:
obtain, from a second network entity, a request for a first configuration for a first mobility operation for a cell switch for a user equipment (UE) to a cell served by the first network entity while using a radio resource control (RRC) connection between the UE and the second network entity for communications between the UE and the first network entity via the cell, the RRC connection being based on the first configuration;
send, to the second network entity, the first configuration for communications between the UE and the first network entity via the cell;
communicate with the UE via the cell based on the first configuration; and
relay traffic between the UE and the second network entity based on the RRC connection.

20. An apparatus configured for wireless communications, comprising:
one or more memories; and
one or more processors coupled to the one or more memories, the one or more processors being configured to cause the apparatus to:
obtain, from a first network entity, a first indication of a radio resource control (RRC) connection for communications between the apparatus and the first network entity;
obtain, from the first network entity via a first cell, a first configuration for a first mobility operation for a cell switch to a second cell served by a second network entity, wherein the first configuration indicates to use the RRC connection for communications between the apparatus and the second network entity via the second cell;
send, to a second network entity via the second cell, a second indication of completion of the first mobility operation; and
communicate with the first network entity via the second cell based on the RRC connection.
